(19) United States
(12) Patent Application Publication
(10) Pub. No.: US 2016/0309173 A1
(43) Pub. Date: Oct. 20, 2016

(54) DEPTH ENCODING METHOD AND APPARATUS, DECODING METHOD AND APPARATUS

(71) Applicant: SAMSUNG ELECTRONICS CO., LTD., Suwon-si (KR)

(72) Inventors: Jin-young LEE, Hwaseong-si (KR); Min-woo PARK, Yongin-si (KR); Yong-jin CHO, Seoul (KR); Byeong-doo CHOI, Suwon-si (KR)

(73) Assignee: SAMSUNG ELECTRONICS CO., LTD., Suwon-si (KR)

(21) Appl. No.: 15/193,329

(22) Filed: Jun. 27, 2016

Related U.S. Application Data
(63) Continuation of application No. PCT/KR2014/012905, filed on Dec. 26, 2014.
(60) Provisional application No. 61/920,862, filed on Dec. 26, 2013.

(51) Int. Cl. H04N 19/33; H04N 19/103; H04N 19/593; H04N 19/18

(52) U.S. Cl. CPC H04N 19/33; H04N 19/18; H04N 19/103; H04N 19/593

(57) ABSTRACT

Provided is a video decoding method including acquiring, from a bitstream, segment-wise direct component (DC) coding (SDC) mode information indicating whether an SDC mode is allowed in a depth image; determining prediction mode information and partition mode information applied to a coding unit of the depth image; acquiring an SDC flag indicating whether an SDC mode is applied to the coding unit from the bitstream according to the SDC mode information, the prediction mode information, and the partition mode information; acquiring a residual DC value corresponding to a prediction unit of the coding unit from the bitstream when the SDC flag indicates that the SDC mode is applied to the coding unit; and reconstructing a current block of the prediction unit by using the residual DC value and prediction values of the prediction unit, wherein the residual DC value is acquired from a residual block of the prediction unit.

### TECHNICAL FIELD

The present invention relates to a method of encoding and decoding a video and, more particularly, to an inter prediction method for a method and an apparatus for) decoding/encoding a depth image of a video.

### BACKGROUND ART

A three-dimensional (3D) video provides depth and spatial shape information together with video information. While a stereoscopic video provides videos of different views to the left and right eyes, a 3D video provides a video shown from a different direction whenever a user changes views. Thus, videos captured in multiple views are required to generate the 3D video.

The videos captured in multiple views to generate the 3D video have an enormous amount of data. Accordingly, in consideration of network infrastructures, terrestrial bandwidths, etc., even when the 3D video is encoded by a coding apparatus optimized for single-view video coding, e.g., MPEG-2, H.264/AVC, or HEVC, implementation thereof is almost impossible.

Therefore, a multi-view (multilayer) video coding apparatus optimized to generate a 3D video is required. Particularly, development of a technology for efficiently reducing temporal and inter-view redundancy is necessary.

For example, a multi-view video codec may increase a compression ratio by encoding base-view pictures by using single-view video coding, and encoding extended-view pictures with reference to the base-view pictures. Furthermore, by additionally encoding auxiliary data such as a depth image, pictures of a larger number of views compared to the number of views of input pictures may be generated by a decoder. In this regard, since the depth image is not directly shown to a user but is used to generate intermediate-view composite pictures, deterioration of the depth image reduces the quality of the composite pictures. Accordingly, the multi-view video codec needs to efficiently encode the depth image as well as the multi-view pictures.

### DETAILED DESCRIPTION OF THE INVENTION

### Technical Problem

### Technical Solution

According to an aspect of the present invention, a video decoding method comprising: acquiring, from a bitstream, segment-wise direct component (DC) coding (SDC) mode information indicating whether an SDC mode is allowed in a depth image; determining prediction mode information and partition mode information applied to a coding unit of the depth image; acquiring an SDC flag indicating whether an SDC mode is applied to the coding unit from the bitstream according to the SDC mode information, the prediction mode information, and the partition mode information; acquiring a residual DC value corresponding to a prediction unit of the coding unit from the bitstream when the SDC flag indicates that the SDC mode is applied to the coding unit; and reconstructing a current block of the prediction unit by using the residual DC value and prediction values of the prediction unit, wherein the residual DC value is acquired from a residual block of the prediction unit.

The SDC mode information comprises: inter SDC mode information indicating whether the SDC mode is allowed when the coding unit is predicted by an inter mode; and intra SDC mode information indicating whether the SDC mode is allowed when the coding unit is predicted by an intra mode.

The acquiring of the SDC flag comprises: acquiring the SDC flag when a prediction mode is the inter mode, in a case where the inter SDC mode information indicates that the SDC mode is allowed with respect to the depth image, and a partition mode is a 2N×2N mode, and acquiring the SDC flag when a prediction mode is the intra mode, in a case where the intra SDC mode information indicates that the SDC mode is allowed with respect to the depth image, and a partition mode is a 2N×2N mode.

The acquiring of the residual DC value comprises: acquiring an absolute value of the residual DC value and, when the absolute value is not 0, acquiring a sign of the residual DC value.

The residual DC value is determined as an average value of one or more residual pixel values of the residual block.

The residual DC value is determined as an average value of a top left residual pixel value, a top right residual pixel value, a bottom left residual pixel value, and a bottom right residual pixel value of the residual block.

The one or more residual pixel values are determined according to a size of at least one of the coding unit and the prediction unit.

The residual DC value is determined from among a plurality of residual DC value candidates by adding multiple offset values to the average value of the one or more residual sample values based on rate-distortion optimization.

According to another aspect of the present invention, a video decoding apparatus comprising: an SDC mode information acquirer for acquiring, from a bitstream, SDC mode information indicating whether an SDC mode is allowed in a depth image; a coding unit information determiner for determining prediction mode information and partition mode information applied to a coding unit of the depth image; an SDC flag acquirer for acquiring an SDC flag indicating whether an SDC mode is applied to the coding unit from the bitstream according to the SDC mode information and coding information; a residual DC value acquirer for acquiring a residual DC value corresponding to a prediction unit of the coding unit from the bitstream when the SDC flag indicates that the SDC mode is applied to the coding unit; and a decoder for reconstructing a current block of the prediction unit by using the residual DC value and prediction values of the prediction unit, wherein the residual DC value is acquired from a residual block of the prediction unit.

The SDC mode information acquirer acquires inter SDC mode information indicating whether the SDC mode is allowed when the coding unit is predicted by an inter mode and acquires intra SDC mode information indicating whether the SDC mode is allowed when the coding unit is predicted by an intra mode.

The SDC flag acquirer acquires the SDC flag when a prediction mode is the inter mode, in a case where the inter SDC mode information indicates that the SDC mode is allowed with respect to the depth image, and a partition mode is a 2N×2N mode, and acquires the SDC flag when a prediction mode is the intra mode, in a case where the intra SDC mode information indicates that the SDC mode is allowed with respect to the depth image, and a partition mode is a 2N×2N mode.

The residual DC value acquirer acquires an absolute value of the residual DC value and then, when the absolute value is not 0, acquires a sign of the residual DC value.

The residual DC value is determined as an average value of one or more residual pixel values of the residual block.

The residual DC value is determined as an average value of a top left residual pixel value, a top right residual pixel value, a bottom left residual pixel value, and a bottom right residual pixel value of the residual block.

The one or more residual pixel values are determined according to a size of at least one of the coding unit and the prediction unit.

The residual DC value is determined from among a plurality of residual DC value candidates by adding multiple offset values to the average value of the one or more residual sample values based on rate-distortion optimization.

According to another aspect of the present invention, a video encoding method comprising: predicting a prediction unit of a coding unit of a depth image and generating a residual block corresponding to the prediction unit; determining SDC mode information indicating whether an SDC mode is allowed with respect to the depth image; determining a residual DC value from the residual block when the SDC mode is applied to the coding unit according to a prediction mode and a partition mode used to generate the residual block; determining prediction mode information and partition mode information with respect to the coding unit; determining an SDC flag indicating whether the SDC mode is applied to the coding unit; and transmitting a bitstream comprising the SDC mode information, the SDC flag, the prediction mode information, the partition mode information, and the residual DC value.

According to another aspect of the present invention, a video encoding apparatus comprising: a residual block generator for generating a residual block corresponding to a prediction unit of a coding unit of a depth image including a depth component of a 3D image; an SDC mode information determiner for determining SDC mode information indicating whether an SDC mode is allowed with respect to the depth image; a residual DC value determiner for determining a residual DC value from the residual block when the SDC mode is applied to the coding unit according to a prediction mode and a partition mode used to generate the residual block; a coding unit information determiner for determining prediction mode information and partition mode information with respect to the coding unit; an SDC flag determiner for determining an SDC flag indicating whether the SDC mode is applied to the coding unit; and a bitstream transmitter for transmitting a bitstream comprising the SDC mode information, the SDC flag, the prediction mode information, the partition mode information, and the residual DC value.

According to another aspect of the present invention, a computer-readable recording medium has recorded thereon a computer program for executing the above-described video encoding method or video decoding method.

### DESCRIPTION OF THE DRAWINGS

FIG. 1A is a block diagram of a video encoding apparatus according to an embodiment. FIG. 1B is a flowchart of a video encoding method according to an embodiment.

FIG. 2A is a block diagram of a video decoding apparatus according to an embodiment. FIG. 2B is a flowchart of a video decoding method according to an embodiment.

FIG. 3A is a diagram for describing a flag indicating whether a segment-wise direct component (DC) coding (SDC) mode is applied to a coding unit. FIG. 3B is a diagram for describing a procedure of acquiring a residual DC value by the video decoding apparatus 200.

FIG. 4 is a flowchart of a method of determining a residual DC value according to an embodiment.

FIG. 5 shows an interlayer prediction structure according to an embodiment.

FIGS. 6A and 6B are flowcharts of a method of encoding a residual block by an interlayer video encoding apparatus based on whether an SDC mode is applied according to an embodiment.

FIGS. 7A and 7B are diagrams for describing examples of generating residual data of a coding unit in a case when a prediction mode is an SDC mode, according to embodiments.

FIG. 8 illustrates a block diagram of a video encoding apparatus based on coding units of a tree structure, according to an embodiment of the present invention.

FIG. 9 illustrates a block diagram of a video decoding apparatus based on coding units of a tree structure, according to an embodiment.

FIG. 10 illustrates a concept of coding units, according to an embodiment.

FIG. 11 illustrates a block diagram of a video encoder based on coding units, according to an embodiment.

FIG. 12 illustrates a block diagram of a video decoder based on coding units, according to an embodiment.

FIG. 13 illustrates deeper coding units according to depths, and partitions, according to an embodiment.

FIG. 14 illustrates a relationship between a coding unit and transformation units, according to an embodiment.

FIG. 15 illustrates a plurality of pieces of encoding information according to depths, according to an embodiment.

FIG. 16 illustrates deeper coding units according to depths, according to an embodiment.

FIGS. 17, 18, and 19 illustrate a relationship between coding units, prediction units, and transformation units, according to an embodiment.

FIG. 20 illustrates a relationship between a coding unit, a prediction unit, and a transformation unit, according to encoding mode information of Table 1.

FIG. 21 illustrates a physical structure of a disc in which a program is stored, according to an embodiment.

FIG. 22 illustrates a disc drive for recording and reading a program by using the disc.

FIG. 23 illustrates an overall structure of a content supply system for providing a content distribution service.

FIG. 24 illustrates an external structure of a mobile phone to which a video encoding method and a video decoding method of the present invention are applied, according to an embodiment.

FIG. 25 illustrates an internal structure of the mobile phone.

FIG. 26 illustrates a digital broadcasting system employing a communication system, according to an embodiment.

FIG. 27 illustrates a network structure of a cloud computing system using a video encoding apparatus and a video decoding apparatus, according to an embodiment.

### MODE OF THE INVENTION

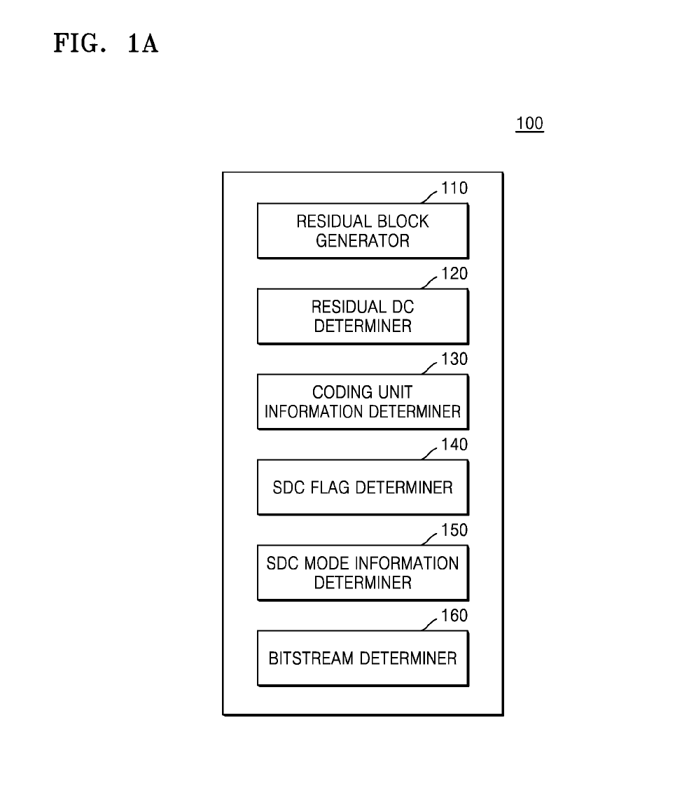

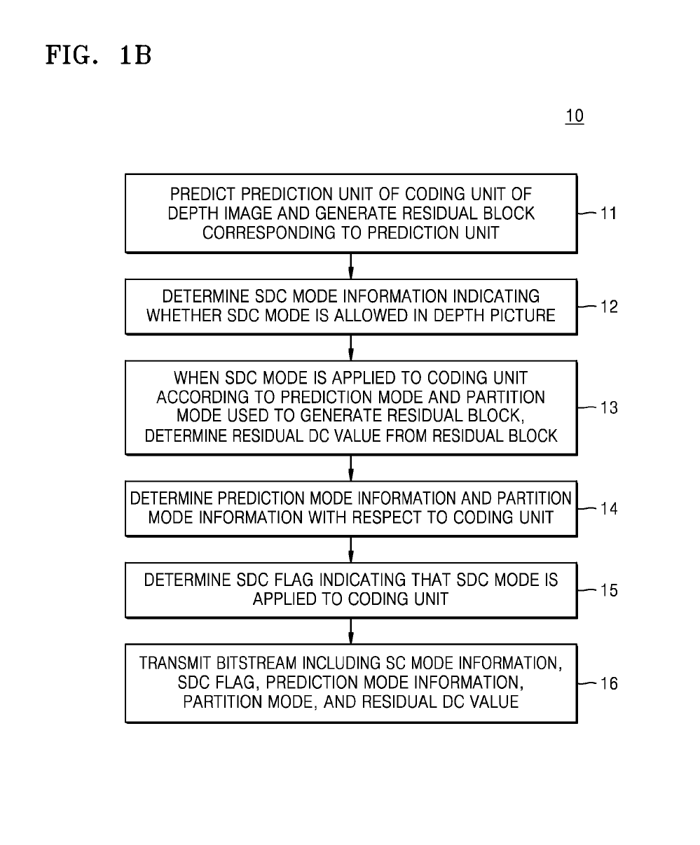

Hereinafter, a SDC mode (a segment-wise direct component (DC) coding mode or a simplified depth coding mode) of a depth image for a video decoding apparatus and method and a video encoding apparatus and method, according to an embodiment, will be described with reference to FIGS. 1A to 7B.

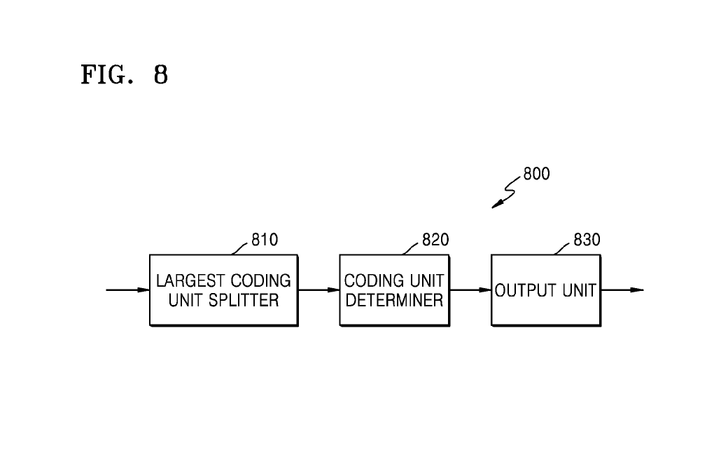

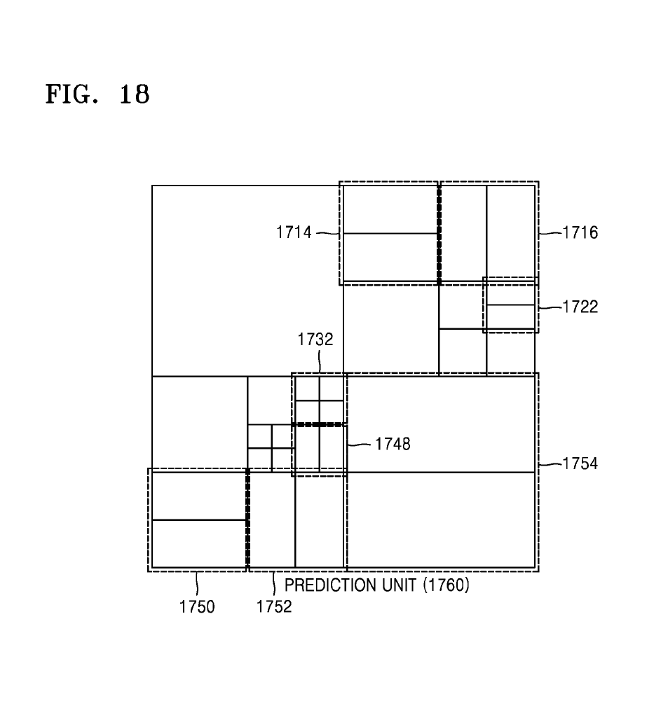

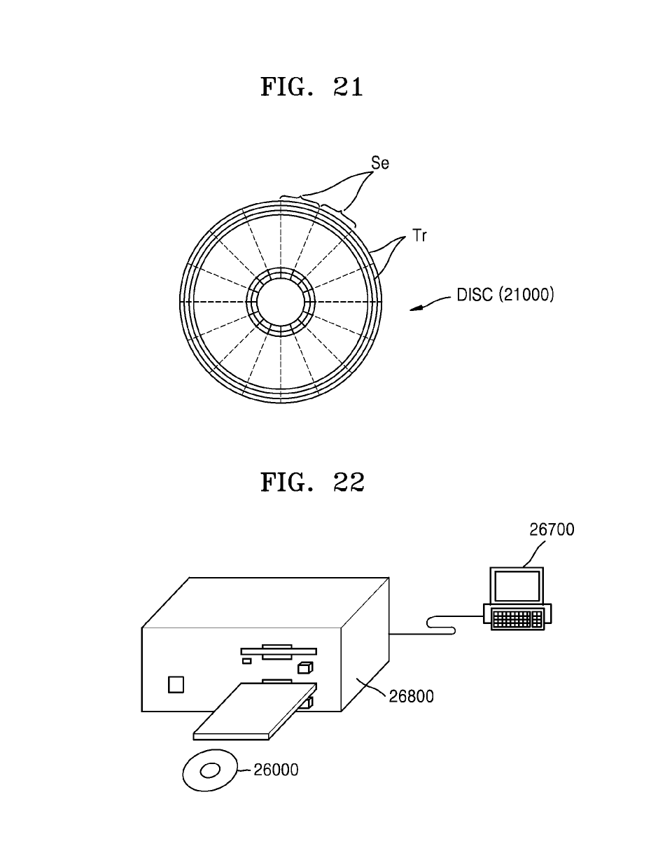

In addition, a video encoding method and a video decoding method based on coding units having a tree structure which are applicable to the above-mentioned video encoding and decoding method according to embodiments will be described with reference to FIGS. 8 to 20. Furthermore, examples to which the above-mentioned video encoding and decoding method is applicable according to embodiments will be described with reference to FIGS. 21 to 27.

In the following description, the term ‘image’ may refer to a still image of a video, or a moving image, i.e., the video itself.

The term ‘sample’ refers to data assigned to an image sampling location and data to be processed. For example, pixels of an image of the spatial domain may be samples.

The term ‘current block’ may refer to a block of a coding unit or a prediction unit of a depth image to be encoded or decoded.

A prediction method of a depth image based on an SDC mode for video decoding apparatus and method and video encoding apparatus and method is now described with reference to FIGS. 1A to 7B.

FIG. 1A is a block diagram of a video encoding apparatus 100 according to an embodiment. FIG. 1B is a flowchart of a video encoding method 10 according to an embodiment.

The video encoding apparatus 100 according to an embodiment may include a residual block generator 110, an SDC mode information determiner 120, a residual DC value determiner 130, a coding unit information determiner 140, an SDC flag determiner 150, and a bitstream determiner 160. The video encoding apparatus 100 according to an embodiment may also include a central processor (not shown) for generally controlling the residual block generator 110, the SDC mode information determiner 120, the residual DC value determiner 130, the coding unit information determiner 140, the SDC flag determiner 150, and the bitstream determiner 160. Alternatively, the residual block generator 110, the SDC mode information determiner 120, the residual DC value determiner 130, the coding unit information determiner 140, the SDC flag determiner 150, and the bitstream determiner 160 may be controlled by individual processors (not shown), and the processors may operate in association with each other to generally control the video encoding apparatus 100. Alternatively, the residual block generator 110, the SDC mode information determiner 120, the residual DC value determiner 130, the coding unit information determiner 140, the SDC flag determiner 150, and the bitstream determiner 160 may be controlled by an external processor (not shown) of the video encoding apparatus 100.

The video encoding apparatus 100 may include one or more data storages (not shown) that store input and output data of the residual block generator 110, the SDC mode information determiner 120, the residual DC value determiner 130, the coding unit information determiner 140, the SDC flag determiner 150, and the bitstream determiner 160. The video encoding apparatus 100 may include a memory controller (not shown) that controls data to be input and output to and from the data storages (not shown).

To output a video encoding result, the video encoding apparatus 100 may perform video encoding operations including transformation in association with an internal or external video encoding processor. The internal video encoding processor of the video encoding apparatus 100 may implement the video encoding operations as a separate processor. Alternatively, the video encoding apparatus 100, a central processing unit, or a graphic processing unit may include a video encoding module to implement basic video encoding operations.

The video encoding apparatus 100 according to an embodiment may classify a plurality of video sequences based on layers by using a scalable video coding scheme, may encode each video sequence, and may output separate streams each including encoded data per layer. The video encoding apparatus 100 may encode a first layer video sequence and a second layer video sequence as different layers.

For example, according to a scalable video coding scheme based on spatial scalability, low-resolution pictures may be encoded as first layer pictures and high-resolution pictures may be encoded as second layer pictures. A result of encoding the first layer pictures may be output as a first layer stream, and a result of encoding the second layer pictures may be output as a second layer stream.

For another example, a multi-view video may be encoded by using a scalable video coding scheme. In this case, center-view pictures may be encoded as first layer pictures, and left-view pictures and right-view pictures may be encoded as second layer pictures which refer to the first layer pictures. Alternatively, when the video encoding apparatus 100 allows three or more layers, e.g., a first layer, a second layer, and a third layer, the center-view pictures may be encoded as first layer pictures, the left-view pictures may be encoded as second layer pictures, and the right-view pictures may be encoded as third layer pictures. However, the layers are not limited to the above-described configuration and the layers assigned to and referred by the center-view, left-view, and right-view pictures may vary.

For another example, a scalable video coding scheme may be performed by using temporal hierarchical prediction based on temporal scalability. A first layer stream including encoding information generated by encoding pictures of a basic frame rate may be output. Temporal layers (temporal levels) may be classified based on frame rates and each temporal layer may be encoded as each layer. A second layer stream including encoding information of a high frame rate may be output by further encoding pictures of the high frame rate with reference to the pictures of the basic frame rate.

Scalable video coding may also be performed on a first layer and a plurality of second layers. When the number of second layers is three or more, first layer pictures, 1^{st} second layer pictures, 2^{nd} second layer pictures, . . . , and K^{th} second layer pictures may be encoded. As such, a result of encoding the first layer pictures may be output as a first layer stream, and a results of encoding the 1^{st}, 2^{nd}, . . . m and K^{th} second layer pictures may be output as 1^{st}, 2^{nd}, and K^{th} second layer streams, respectively.

The video encoding apparatus 100 according to an embodiment may perform inter prediction to predict a current picture with reference to pictures of a single layer. Through inter prediction, a motion vector indicating motion information between a current picture and a reference picture, and a residual value between the current picture and the reference picture may be generated

The video encoding apparatus 100 may also perform interlayer prediction to predict second layer pictures with reference to first layer pictures.

When the video encoding apparatus 100 allows three or more layers, e.g., a first layer, a second layer, and a third layer, the video encoding apparatus 100 may also perform interlayer prediction between one first layer picture and third layer pictures and perform interlayer prediction between second layer pictures and third layer pictures by using a multilayer prediction structure.

Through interlayer prediction, a location difference value between a current picture and a reference picture of another layer and a residual value between the current picture and the reference picture of the other layer may be generated.

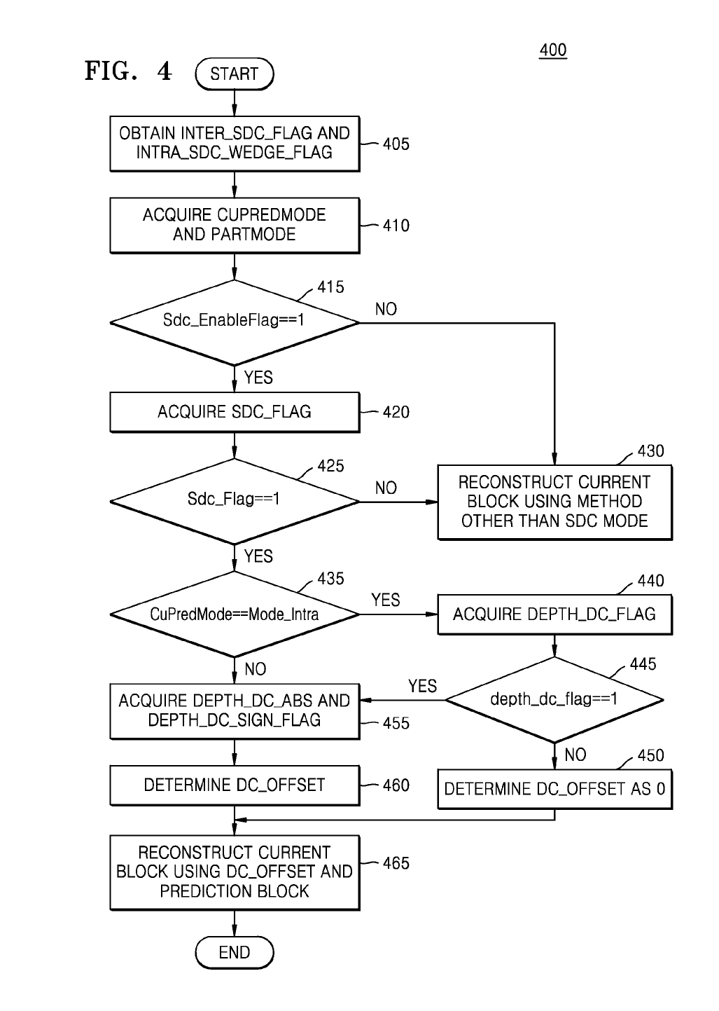

A detailed description of the interlayer prediction structure will be given below with reference to FIG. 4.

The video encoding apparatus 100 according to an embodiment encodes each picture of a video per block, in each layer. The block may have a square shape, a rectangular shape, or a geometric shape, and is not limited to a certain-sized data unit. The block may be the largest coding unit, a coding unit, a prediction unit, a transformation unit, or the like among coding units having a tree structure. The largest coding unit including the coding units having a tree structure may be variously named as a coding tree unit, a coding block tree, a block tree, a root block tree, a coding tree, a coding root, or a tree trunk. A video encoding/decoding scheme based on coding units having a tree structure will be described below with reference to FIGS. 8 to 20.

When the video encoding apparatus 100 according to an embodiment encodes a multi-view video, by additionally encoding auxiliary data such as a depth image, pictures of a larger number of views than the number of views that are to be input may be generated by a decoder. In this regard, since the depth image is not directly viewed to a user but is used to generate intermediate-view composite pictures, deterioration of the depth image may influence the quality of the composite pictures.

A variation in a depth value of the depth image is large near the edge of an object and is relatively small in the object. Accordingly, errors of the composite pictures may be minimized by minimizing errors generated at the edge of the object where the variation in the depth value is large. Encoding efficiency of the depth image may also be increased by relatively reducing the amount of data of the inside of the object where the variation in the depth value is small and a background region.

Accordingly, the video encoding apparatus 100 may increase encoding efficiency of the depth image by encoding a current block by using an SDC mode. In a conventional inter frame prediction mode, sample values of a residual block generated during a procedure of predicting a current block are compressed through an encoding procedure including transformation and quantization, whereas, in the SDC mode, the residual block is not compressed or is compressed to a residual DC value. The residual DC value is a value representative of the pixel values of the residual block and may be determined as an average value of all or some of the pixel values of the residual block.

When the current block is predicted in an inter mode, the video encoding apparatus 100 transmits a bitstream including a reference picture index indicating a reference block of a prediction unit, a motion vector and a residual DC value corresponding to the residual block.

When the current block is predicted in an intra mode, the video encoding apparatus 100 transmits a bitstream including information regarding an intra prediction mode used to predict the current block and the residual DC value corresponding to the residual block.

The residual block generator 110 predicts a current block to generate a residual block corresponding to the current block. When the current block is predicted by an inter mode, the residual block generator 110 generates the residual block by differentiating between the current block and a reference block indicated by a motion vector and a reference picture index. When the current block is predicted by an intra mode, the residual block generator 110 generates the residual block by differentiating the current block and a prediction block generated by an intra prediction mode.

The SDC mode information determiner 120 determines segment-wise DC coding mode information (hereinafter referred to as ‘SDC mode information’) regarding a depth image included in an arbitrary layer. The SDC mode information is information indicating whether an SDC mode is allowed in the depth image. If the SDC mode information indicates that the SDC mode is allowed in the depth image, the SDC mode may be applied according to an SDC flag with respect to a coding unit in a decoding step.

The SDC mode information may include intra segment-wise DC coding mode information (hereinafter referred to as ‘intra SDC mode information’) and inter segment-wise DC coding mode information (hereinafter referred to as ‘inter SDC mode information’). The intra SDC mode information is information indicating whether the SDC mode is allowed in a coding unit when the coding unit is predicted by an intra prediction mode. The inter SDC mode information is information indicating whether the SDC mode is allowed in a coding unit when the coding unit is predicted by an inter prediction mode.

The SDC mode information may be implemented in the form of a flag. For example, a flag with respect to the intra SDC mode information may be expressed as sdc_intra_wedge_flag. If sdc_intra_wedge_flag indicates 0, the SDC mode is not applied to the coding unit predicted by the intra prediction mode. Otherwise, if sdc_intra_wedge_flag indicates 1, the SDC mode is applied to the coding unit predicted by the intra prediction mode.

For another example, a flag with respect to the inter SDC mode information may be expressed as sdc_inter_flag. If sdc_inter_flag indicates 0, the SDC mode is not applied to the coding unit predicted by the inter prediction mode. Otherwise, if sdc_inter_flag indicates 1, the SDC mode is applied to all coding units predicted by the inter prediction mode.

The intra SDC mode information flag and the inter SDC mode information flag may be transmitted in a VPS, an SPS, a PPS, or a slice unit.

The residual DC value determiner 130 determines a residual DC value from a residual block when the SDC mode is applied to a coding unit.

The residual DC value determiner 130 may determine a residual DC value from a residual block corresponding to a prediction unit of a coding unit to which the SDC mode is applied. Specifically, the residual DC value determiner 130 may determine an average value of one or more residual sample values included in the residual block, as the residual DC value.

Accordingly, the residual DC value determiner 130 may determine an average value of all residual sample values as the residual DC value. Likewise, the residual DC value determiner 130 may select only some of the residual sample values and may determine an average value of the selected residual sample values as the residual DC value.

If an average value of some of the residual sample values is calculated, the residual DC value determiner 130 may select residual sample values based on a partition size of the coding unit or the prediction unit.

Alternatively, the residual DC value determiner 130 may determine an average value of residual sample values located at apexes of the residual block as the residual DC value. Specifically, an average value of a top left residual sample value, a top right residual sample value, a bottom left residual sample value, and a bottom right residual sample value of the residual block may be determined as the residual DC value.

For another example, the residual DC value determiner 130 may determine an average value of the residual sample values located at the apexes of the residual block and residual sample values located at a center of the residual block as the residual DC value.

The residual DC value determiner 130 may determine an optimal residual DC value among a plurality of residual DC value candidates. The residual DC value determiner 130 may acquire an average value of one or more residual sample values, and then acquire a plurality of residual DC value candidates by adding multiple offset values to the average value. For example, when the average value is 3 and the offset values are −2, −1, 0, 1, and 2, the residual DC value determiner 130 may acquire five residual DC value candidates having values 1, 2, 3, 4, and 5.

Thereafter, the residual DC value determiner 130 may determine an optimal residual DC value among the residual DC value candidates based on rate-distortion optimization. Rate-distortion optimization is a procedure of selecting an optimal compression method among compression methods selectable for an encoding target picture in consideration of a compression ratio and deterioration of an encoded picture. Therefore, based on rate-distortion optimization, the residual DC value determiner 130 may determine a residual DC value optimized for the encoding target picture among the residual DC value candidates.

For example, when the residual DC value candidates have the values 1, 2, and 3, the residual DC value determiner 130 encodes an encoding target picture by using the residual DC value candidate having the value 1, and then calculates a bitrate of the encoded picture and an error between the encoding target picture and the encoded picture. The bitrate and the error are used to calculate R-D cost. Likewise, the residual DC value determiner 130 performs the same procedure on the other residual DC value candidates having the values 2 and 3. Thereafter, the residual DC value determiner 130 may determine an optimal residual DC value by comparing the R-D cost of the residual DC value candidates.

The residual DC value determiner 130 may not determine the residual DC value. If a small encoding error is predicted when the residual block is encoded by determining the residual DC value, the residual block may not be encoded.

The residual DC value determiner 130 may split the residual DC value into an absolute value of the residual DC value and a sign of the residual DC value.

The coding unit information determiner 140 may determine prediction mode information and partition mode information with respect to a coding unit of a layer. The prediction mode information indicates which prediction mode between an intra prediction mode and an inter prediction mode is applied. For example, the prediction mode information may indicate that the intra prediction mode is applied to the coding unit. The partition mode information indicates an applied partition mode. For example, the partition mode information may indicate that a 2N×2N mode is applied to the coding unit.

The SDC flag determiner 150 determines a segment-wise DC coding flag (hereinafter referred to as an ‘SDC flag’) indicating whether the SDC mode is applied to the coding unit.

According to an embodiment, the SDC flag may be specifically expressed as sdc_flag. For example, when the SDC mode is applied to the coding unit, sdc_flag is set as 1. When the SDC mode is not applied to the coding unit, sdc_flag is set as 0.

The SDC flag determiner 150 may determine whether to generate the ‘SDC flag’ based on a partition mode of the coding unit. For example, when a partition mode in which the SDC mode is allowed is applied to the coding unit, the SDC flag is generated with respect to the coding unit to which the 2N×2N mode is applied. Otherwise, when the partition mode is a 2N×N mode, an N×2N mode, an N×N mode, etc., the SDC flag is not generated.

The bitstream determiner 160 transmits a bitstream including the SDC mode information, the SDC flag, the prediction mode information, the partition mode information, and the residual DC value.

The bitstream determiner 160 may transmit the residual DC value in separate parts as the absolute value of the residual DC value and the sign of the residual DC value.

A detailed description of the video encoding method 10 of the video encoding apparatus 100 according to an embodiment is now given with reference to FIG. 1B.

In operation 11, a prediction unit of a coding unit of a depth image including a depth component of a 3D picture is predicted to generate a residual block corresponding to the prediction unit.

In operation 12, SDC mode information indicating whether an SDC mode is allowed in a current picture is determined. The SDC mode information may include inter SDC mode information and intra SDC mode information.

In operation 13, when the SDC mode is applied to the coding unit, a residual DC value is determined from the residual block.

The residual DC value is determined from the residual block corresponding to the prediction unit of the coding unit to which the SDC mode is applied. Specifically, an average value of one or more residual sample values included in the residual block is determined as the residual DC value. For example, an average value of all residual sample values may be determined as the residual DC value.

Likewise, an average value of some selected from the residual sample values may be determined as the residual DC value. If an average value of some of the residual sample values is calculated, the residual sample values may be selected based on a partition size of the coding unit or the prediction unit.

An average value of a top left residual sample value, a top right residual sample value, a bottom left residual sample value, and a bottom right residual sample value of the residual block may be determined as the residual DC value. For another example, an average value of the top left residual sample value, the top right residual sample value, the bottom left residual sample value, and the bottom right residual sample value of the residual block and residual sample values located at a center of the residual block may be determined as the residual DC value.

An optimal residual DC value may be determined among a plurality of residual DC value candidates. An average value of one or more residual sample values may be acquired, and then a plurality of residual DC value candidates by adding multiple offset values to the average value may be acquired. An optimal residual DC value among the residual DC value candidates may be determined based on rate-distortion optimization.

In operation 14, prediction mode information and partition mode information with respect to the coding unit are determined. The prediction mode information and the partition mode information are determined according to the prediction mode and the partition mode used during a prediction procedure of operation 11.

In operation 15, an SDC flag indicating that the SDC mode is applied to the coding unit is determined. The SDC flag is determined according to whether the SDC mode is applied in operation 12.

In operation 16, a bitstream including the SC mode information, the SDC flag, the prediction mode information, the partition mode, and the residual DC value is transmitted.

According to the above description, the video encoding apparatus 100 may efficiently encode a depth image by reducing the amount of data of a residual block that is a difference in sample values between a current block and a reference block.

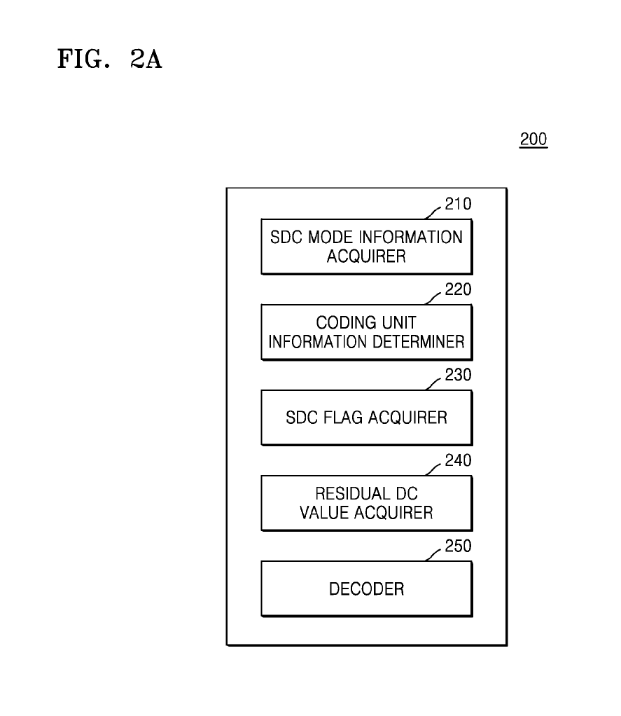

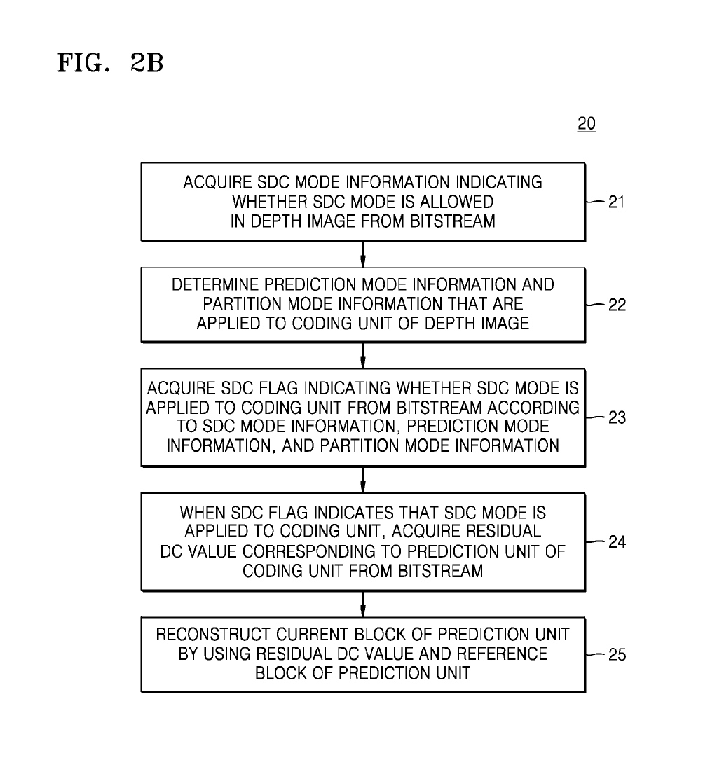

FIG. 2A is a block diagram of a video decoding apparatus 200 according to an embodiment.

The video decoding apparatus 200 according to an embodiment includes an SDC mode information acquirer 210, a coding unit information determiner 220, an SDC flag acquirer 230, a residual DC value acquirer 240, and a decoder 250. The video decoding apparatus 200 according to an embodiment may include a central processor (not shown) that generally controls all of the SDC mode information acquirer 210, the coding unit information determiner 220, the SDC flag acquirer 230, the residual DC value acquirer 240, and the decoder 250. Alternatively, the SDC mode information acquirer 210, the coding unit information determiner 220, the SDC flag acquirer 230, the residual DC value acquirer 240, and the decoder 250 may be controlled by individual processors (not shown), and the processors may operate in association with each other to generally control the video decoding apparatus 200. Alternative, the SDC mode information acquirer 210, the coding unit information determiner 220, the SDC flag acquirer 230, the residual DC value acquirer 240, and the decoder 250 may be controlled by an external processor (not shown) of the video decoding apparatus 200 according to an embodiment.

The video decoding apparatus 200 may include one or more data storages (not shown) that store input and output data of the SDC mode information acquirer 210, the coding unit information determiner 220, the SDC flag acquirer 230, the residual DC value acquirer 240, and the decoder 250. The video decoding apparatus 200 may include a memory controller (not shown) that controls data to be input and output to and from the data storages (not shown).

To reconstruct a video by decoding the video, the video decoding apparatus 200 according to an embodiment may perform video decoding operations including inverse transformation in association with an internal or external video decoding processor. The internal video decoding processor of the video decoding apparatus 200 according to an embodiment may implement the video decoding operations as a separate processor as well as the video decoding apparatus 200, a central processing unit, or a graphic processing unit may include a video decoding module to implement basic video decoding operations.

The video decoding apparatus 200 according to an embodiment may receive bitstreams including information regarding a plurality of layers by using a scalable coding scheme. The number of layers of the bitstreams received by the video decoding apparatus 200 is not limited.

For example, the video decoding apparatus 200 based on spatial scalability may receive streams in which video sequences having different resolutions are encoded in different layers. A low-resolution video sequence may be reconstructed by decoding a first layer stream, and a high-resolution video sequence may be reconstructed by decoding a second layer stream.

For another example, a multi-view video may be decoded by using a scalable video coding scheme. When stereoscopic video streams of multiple layers are received, left-view pictures may be reconstructed by decoding a first layer stream. Right-view pictures may be reconstructed by further decoding a second layer stream in addition to the first layer stream.

Alternatively, when multi-view video streams of multiple layers are received, center-view pictures may be reconstructed by decoding a first layer stream. Left-view pictures may be reconstructed by further decoding a second layer stream in addition to the first layer stream. Right-view pictures may be reconstructed by further decoding a third layer stream in addition to the first layer stream.

For another example, a scalable video coding scheme based on temporal scalability may be performed. Pictures of a basic frame rate may be reconstructed by decoding a first layer stream. Pictures of a high frame rate may be reconstructed by further decoding a second layer stream in addition to the first layer stream.

When the number of second layers is three or more, first layer pictures may be reconstructed from a first layer stream, and second layer pictures may be further reconstructed by further decoding a second layer stream with reference to the reconstructed first layer pictures. K^{th} layer pictures may be further reconstructed by further decoding a K^{th} layer stream with reference to the reconstructed second layer pictures.

The video decoding apparatus 200 may acquire encoded data of first layer pictures and second layer pictures from a first layer stream and a second layer stream, and may further acquire a motion vector generated through inter prediction and prediction information generated through interlayer prediction.

For example, the video decoding apparatus 200 may decode data inter-predicted per layer, and may decode data interlayer-predicted among multiple layers. Reconstruction may be implemented by performing motion compensation and interlayer decoding based on a coding unit or a prediction unit.

Pictures may be reconstructed by performing motion compensation on a current picture with reference to reconstructed pictures which are predicted through inter prediction of the same layer with respect to each layer stream. Motion compensation refers to an operation of reconfiguring a reconstructed image of a current picture by synthesizing a reference picture determined by using a motion vector of the current picture and a residual value of the current picture.

The video decoding apparatus 200 may also perform interlayer decoding with reference to prediction information of the first layer pictures to decode the second layer pictures predicted through interlayer prediction. Interlayer decoding refers to an operation of reconfiguring prediction information of a current picture by using prediction information of a reference block of another layer to determine the prediction information of the current picture.

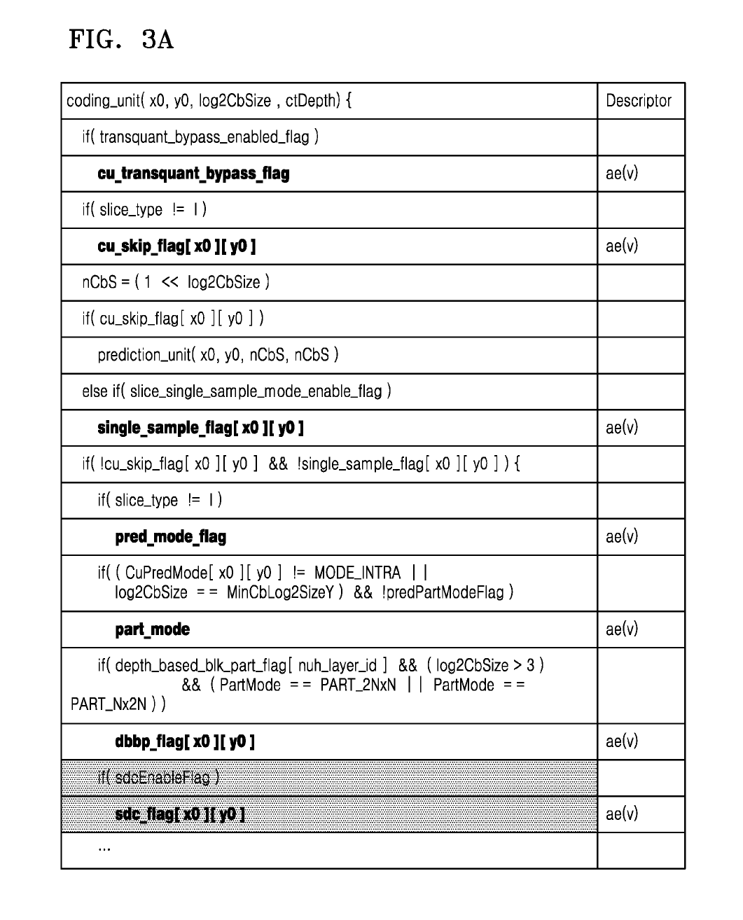

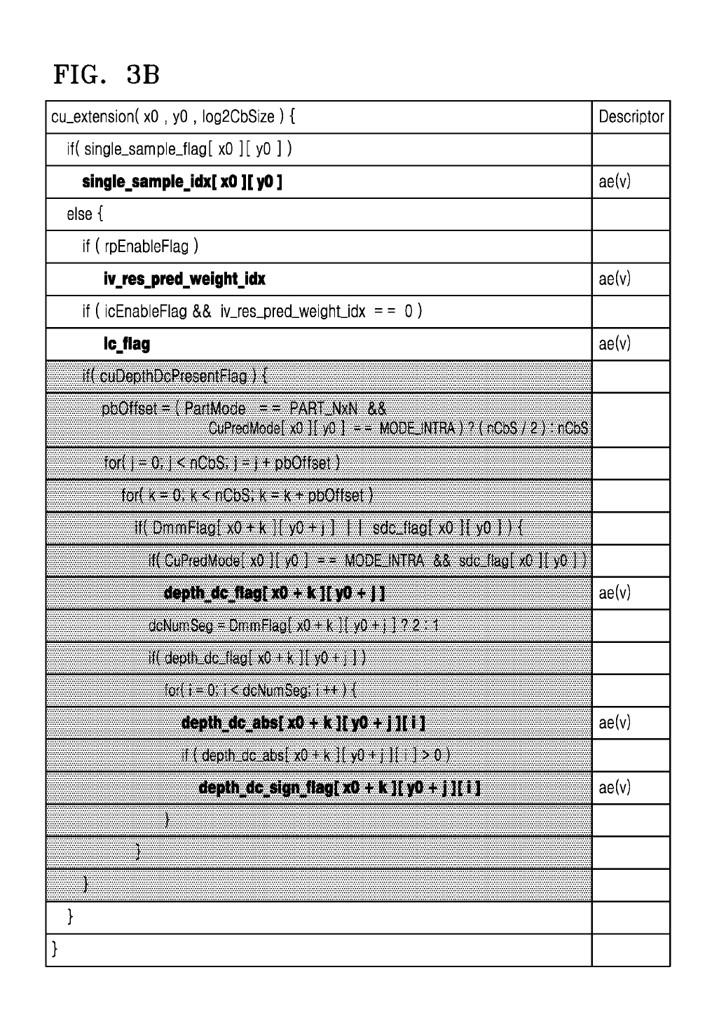

The video decoding apparatus 200 according to an embodiment may perform interlayer decoding to reconstruct third layer pictures predicted with reference to the second layer pictures. A detailed description of the interlayer prediction structure will be given below with reference to FIG. 3.

The video decoding apparatus 200 decodes each image of a video per block. The block may be the largest coding unit, a coding unit, a prediction unit, a transformation unit, or the like among coding units having a tree structure. A video encoding/decoding scheme based on coding units having a tree structure will be described below with reference to FIGS. 8 to 20.

In an SDC mode, the video decoding apparatus 200 determines a reference block by using a reference picture index and a motion vector, and decodes a current block of the coding unit by using the reference block and the residual DC value. Specifically, the current block may be decoded by adding the residual DC value to all sample values of the reference block.

The SDC mode information acquirer 210 acquires SDC mode information regarding a depth image from a bitstream. The SDC mode information is information indicating whether the SDC mode is allowed in the depth image. When the SDC mode information indicates that the SDC mode is allowed in the depth image, the SDC mode may be applied to a coding unit of the depth image according to an SDC flag that will be described later.

The SDC mode information may include intra SDC mode information and inter SDC mode information. The intra SDC mode information is information indicating whether the SDC mode is allowed in the coding unit when the coding unit is predicted by an intra prediction mode. The inter SDC mode information is information indicating whether the SDC mode is allowed in the coding unit when the coding unit is predicted by an inter prediction mode.

The SDC mode information may be implemented in the form of a flag. For example, the intra SDC mode information may be expressed as sdc_intra_wedge_flag. If sdc_intra_wedge_flag indicates 0, the SDC mode is not applied to the coding unit predicted by the intra prediction mode. Otherwise, if sdc_intra_wedge_flag indicates 1, it is determined if the SDC mode is applied to the coding unit predicted by the intra prediction mode.

For another example, the inter SDC mode information may be expressed as sdc_inter_flag. If sdc_inter_flag indicates 0, the SDC mode is not applied to the coding unit predicted by the inter prediction mode. Otherwise, if sdc_inter_flag indicates 1, it is determined if the SDC mode is applied to the coding unit predicted by the inter prediction mode.

The coding unit information acquirer 220 may acquire a prediction mode and a partition mode with respect to a coding unit of the depth image. Prediction mode information indicates which prediction mode is applied to the coding unit between the intra prediction mode and the inter prediction mode. Partition mode information indicates which partition mode is applied to the coding unit. For example, the partition mode information may indicate that a 2N×2N mode is applied to the coding unit.

The SDC flag acquirer 230 acquires an SDC flag indicating whether the SDC mode is applied to the coding unit of the depth image. The SDC flag is information indicating whether the SDC mode is applied to the coding unit. According to an embodiment, the SDC flag may be expressed as sdc_flag. If sdc_flag indicates 0, the inter SDC mode is not applied to a coding unit corresponding to sdc_flag. Otherwise, if sdc_flag indicates 1, the inter SDC mode is applied to the coding unit corresponding to sdc_flag.

The SDC flag acquirer 230 may determine whether to acquire the SDC flag based on the SDC mode information, the prediction mode information, and the partition mode information. For example, when a prediction mode of a coding unit is an inter mode, the SDC flag acquirer 230 may acquire the SDC flag if an inter SDC mode information flag indicates 1 and a partition mode is the 2N×2N mode. For another example, when the prediction mode of the coding unit is an intra mode, the SDC flag acquirer 230 may acquire the SDC flag if an intra SDC mode information flag indicates 1 and the partition mode is the 2N×2N mode.

The SDC flag acquirer 230 does not acquire the SDC flag when a predetermined condition is not satisfied. If the SDC flag is not acquired, it is determined that the SDC mode is not applied to a current block.

The residual DC value acquirer 240 may acquire a residual DC value from a bitstream with respect to the prediction unit of the coding unit to which the SDC mode is applied. The residual DC value may be a value determined from a residual block generated during an encoding procedure.

The residual DC value acquirer 240 may acquire the residual DC value from the bitstream when the SDC flag indicates that the SDC mode is applied to the coding unit. Otherwise, when the SDC flag indicates that the SDC mode is not applied to the coding unit, the residual DC value acquirer 240 may not acquire the residual DC value.

The residual DC value may be an average value of all residual sample values. For another example, the residual DC value may be an average value of residual sample values selected from residual sample values.

The residual DC value may be an average value of residual sample values selected according to a partition size of the coding unit or the prediction unit. Alternatively, the residual DC value may be an average value of residual sample values located at apexes of a residual block. For another example, the residual DC value may be an average value of the residual sample values located at the apexes of the residual block and residual sample values located at a center of the residual block.

The residual DC value may be an optimal residual DC value determined among a plurality of residual DC value candidates.

If a small encoding error is predicted when the residual block is encoded by determining the residual DC value during the encoding procedure, the residual DC value may not be generated. When the residual DC value is not generated, the residual DC value acquirer 240 may note acquire the residual DC value. When the residual DC value is not acquired, a prediction block of the prediction unit is determined as the current block.

The residual DC value acquirer 240 may separately acquire information of an absolute value of the residual DC value and information of a sign of the residual DC value. The residual DC value acquirer 240 may determine the residual DC value by using the information of the absolute value and the sign of the residual DC value.

The decoder 250 may reconstruct the current block of the prediction unit by using the residual DC value acquired by the residual DC value acquirer 240 and prediction values of the prediction unit. For example, the decoder 2250 may reconstruct the current block of the prediction unit by adding the residual DC value to the prediction values of the prediction unit.

The decoder 250 generates the prediction values of the prediction unit according to the prediction mode and the partition mode.

When the prediction mode is an inter mode, the decoder 250 performs inter prediction by using a partition indicated by the partition mode. More specifically, the decoder 250 acquires a prediction value from a reference block indicated by the prediction unit and reconstructs the current block by using the prediction value and the residual DC value.

When the prediction mode is an intra mode, the decoder 250 performs intra prediction by using the partition indicated by the partition mode. More specifically, the decoder 250 determines a padding sample according to an intra prediction direction. The decoder 250 acquires a prediction value from the padding sample and reconstructs the current block by using the prediction value and the residual DC value.

A detailed description of a video decoding method 20 of the video decoding apparatus 200 according to an embodiment is now given with reference to FIG. 2B.

In operation 21, segment-wise DC coding mode information (hereinafter referred to as ‘SDC mode information’) indicating whether an SDC mode is allowed in a depth image is acquired from a bitstream.

The SDC mode information may include inter SDC mode information indicating whether an SDC mode is allowed when a coding unit is predicted by an inter mode and intra SDC mode information indicating whether the SDC mode is allowed when the coding unit is predicted by an intra mode.

In operation 22, prediction mode information and partition mode information that are applied to a coding unit of the depth image are determined.

In operation 23, an SDC flag indicating whether the SDC mode is applied to the coding unit is acquired from the bitstream according to the SDC mode information, prediction mode information, and partition mode information.

When a prediction mode of the coding unit is the inter mode, the inter SDC mode information indicates that the SDC mode is allowed in a current depth image. When a partition mode of the coding unit is a 2N×2N mode, the SDC flag is acquired.

When the prediction mode of the coding unit is the intra mode, the intra SDC mode information indicates that the SDC mode is allowed in the current depth image. When the partition mode of the coding unit is the 2N×2N mode, the SDC flag is acquired.

In operation 24, when the SDC flag indicates that the SDC mode is applied to the coding unit, a residual DC value corresponding to the prediction unit of the coding unit is acquired from the bitstream.

An absolute value of the residual DC value and a sign of the residual DC value are sequentially acquired. The residual DC value may be determined by using the absolute value of the residual DC value and the sign of the residual DC value.

In operation 25, the current block of the prediction unit is reconstructed by using the residual DC value and the prediction values of the prediction unit.

According to the above description, the video decoding apparatus 200 may decode a current block of a coding unit which is encoded in the SDC mode by the video encoding apparatus 100.

FIG. 3A is a diagram for describing an operation of acquiring a flag indicating whether an SDC mode is applied to a coding unit by the video decoding apparatus 200. FIG. 3A illustrates a coding_unit syntax.

sdcEnableFlag is a flag indicating whether to acquire sdc_flag[x0][y0]. When sdcEnableFlag is 1, the video decoding apparatus 200 acquires sdc_flag[x0][y0] from a bitstream. When sdcEnableFlag is 0, the video decoding apparatus 200 does not acquire sdc_flag[x0][y0] from the bitstream, and sdc_flag[x0][y0] has a default value.

sdcEnableFlag has a value of 1 in a case where an inter SDC mode information flag is 1 and a partition mode of the coding unit is 2N×2N when an inter prediction mode is applied to the coding unit. Otherwise, when the above condition is not satisfied, sdcEnableFlag has a value of 0.

sdcEnableFlag has a value of 1 in a case where an intra SDC mode information flag is 1 and the partition mode of the coding unit is 2N×2N when an intra prediction mode is applied to the coding unit. Otherwise, when the above condition is not satisfied, sdcEnableFlag has a value of 0.

sdc_flag[x0][y0] indicates whether the SDC mode is applied to a coding unit corresponding to a pixel located at an x0th column from the left and at a y0th row from the top in a depth image. When sdc_flag[x0] [y0] is 1, the SDC mode is applied to a coding unit corresponding to sdc_flag[x0][y0]. Otherwise, when sdc_flag[x0][y0] is 0, the SDC mode is not applied to the coding unit corresponding to sdc_flag[x0][y0].

If sdc_flag[x0] [y0] is not defined, sdc_flag[x0][y0] is estimated to be 0. Thus, when sdcEnableFlag is 0, since sdc_flag[x0][y0] is not acquired from the bitstream, sdc_flag[x0] [y0] is estimated to be 0. Thus, the SDC mode is not applied to the coding unit.

FIG. 3B is a diagram for describing a procedure of acquiring a residual DC value by the video decoding apparatus 200. FIG. 3B illustrates a cu_extension syntax.

cuDepthDcPresentFlag indicates whether a residual DC value corresponding to a prediction unit of a coding unit is present. The residual DC value is present when a current block is encoded by an SDC mode.

The SDC mode is applied only when a partition mode is 2N×2N, and thus a value of pbOffset is the same as that of nCbS. Thus, the residual DC value is acquired only with respect to a prediction unit having the same size as that of a coding unit. The syntax is analyzed on the assumption that k and j are the same as 0 below.

depth_dc_flag[x0][y0] indicates whether a residual DC value is 0 in a prediction unit. Only when a prediction mode of a coding unit is an intra mode, depth_dc_flag[x0][y0] is acquired from a bitstream. When depth_dc_flag[x0][y0] is 1, the residual DC value is not 0. Thus, the residual DC value is determined by using depth_dc_abs[x0][y0] and depth_dc_sign_flag[x0][y0] acquired from the bitstream. When depth_dc_flag[x0][y0] is 0, since the residual DC value is 0, depth_dc_abs[x0][y0] and depth_dc_sign_flag[x0] [y0] are not acquired.

When the prediction mode of the coding unit is an inter mode, depth_dc_flag[x0][y0] is not acquired. Thus, the residual DC value is determined by using depth_dc_abs[x0][y0] and depth_dc_sign_flag[x0][y0] acquired from the bitsream irrespective of depth_dc_flag[x0] [y0].

depth_dc_abs[x0][y0] indicates an absolute value of the residual DC value. depth_dc_sign_flag [x0] [y0] indicates a sign of the residual DC value. Thus, depth_dc_abs[x0][y0] indicates 8, and depth_dc_sign_flag[x0][y0] indicates −, the residual DC value is −8.

For another example, the residual DC value may be determined through an arbitrary calculation after acquiring depth_dc_abs[x0] [y0] and depth_dc_sign_flag[x0] [y0]. If depth_dc_abs[x0][y0] indicates 8, an absolute value of the residual DC value may be determined as 9 by adding 1 to depth_dc_abs[x0][y0]. Thus, when depth_dc_sign_flag[x0] [y0] indicates −, the residual DC value is −9.

FIG. 4 is a flowchart of a method 400 of determining a residual DC value in an SDC mode according to an embodiment. The flowchart of FIG. 4 is configured based on the coding_unit syntax and the cu_extension syntax described with reference to FIGS. 3A and 3B, respectively.

In operation 405, inter_sdc_flag and intra_sdc_wedge_flag are acquired. inter_sdc_flag means inter SDC mode information. intra_sdc_wedge_flag means intra SDC mode information. An inter SDC flag and an intra SDC flag may be expressed as syntaxes other than inter_sdc_flag and intra_sdc_wedge_flag.

In operation 410, CuPredMode and PartMode are acquired. CuPredMode means a prediction mode applied to a coding unit. PartMode indicates a partition mode applied to the coding unit.

In operation 415, it is determined whether SdcEnableFlag is 1. When a coding mode is an inter mode, inter_sdc_flag is 1. When a partition mode is 2N×2N, SdcEnableFlag is 1. If the above condition is not satisfied, SdcEnableFlag is 0. When the coding mode is an intra mode, intra_sdc_wedge_flag is 1. When the partition mode is 2N×2N, SdcEnableFlag is 1. If the above condition is not satisfied, SdcEnableFla is 0.

When SdcEnableFlag is 1, the method proceeds to operation 420. When SdcEnableFlag is 0, the method proceeds to operation 430.

In operation 420, Sdc_Flag is acquired from a bitstream. Sdc_Flag means an SDC flag.

In operation 425, it is determined whether Sdc_Flag acquired in operation 420 is 1. When Sdc_Flag is 1, the method proceeds to operation 435. When Sdc_Flag is 0, the method proceeds to operation 430.

In operation 430, a current block is decoded using a method other than the SDC mode. For example, a residual block may be reconstructed through entropy decoding, inverse quantization, and inverse transformation performed on encoded data. The reconstructed residual block and a prediction block may be used to reconstruct the current block.

In operation 435, it is determined whether CuPredMode indicates an intra prediction mode. When CuPredMode indicates the intra prediction mode, the method proceeds to operation 440. When CuPredMode indicates an inter prediction mode, the method proceeds to operation 455.

In operation 440, depth_dc_flag is acquired. depth_dc_flag indicates whether the residual DC value is 0.

In operation 445, it is determined whether depth_dc_flag acquired in operation 440 is 1. When Sdc_Flag is 1, the method proceeds to operation 455. When Sdc_Flag is 0, the method proceeds to operation 450.

In operation 450, DC_offset is determined to be 0. DC_offset means the residual DC value.

In operation 455, depth_dc_abs and depth_dc_sign_flag are acquired. depth_dc_abs means an absolute value of DC_offset. depth_dc_sign_flag means a sign of DC_offset.

In operation 460, DC_offset is determined using depth_dc_abs and depth_dc_sign_flag acquired in operation 455.

In operation 465, the current block is reconstructed using DC_offset determined in operations 450 and 460 and the prediction block.

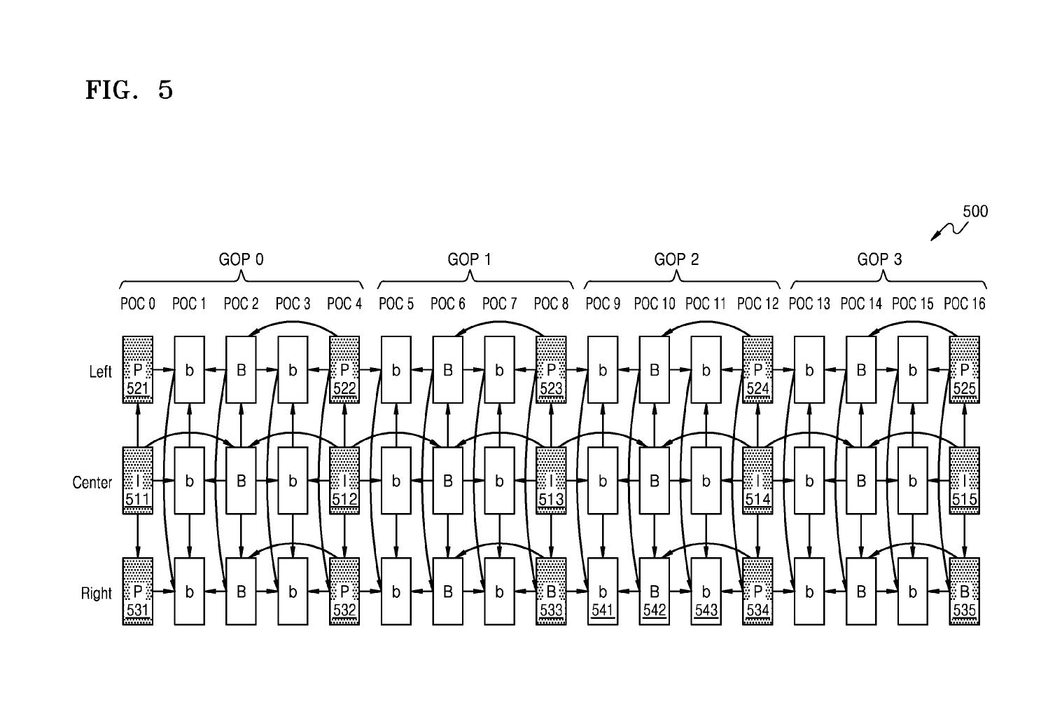

FIG. 5 illustrates an interlayer prediction structure according to an embodiment.

The video encoding apparatus 100 according to an embodiment may prediction-encode base-view pictures, left-view pictures, and right-view pictures based on a reproduction order 500 of the multi-view video prediction structure illustrated in FIG. 5.

Based on the reproduction order 500 of the multi-view video prediction structure according to a related art, pictures of the same view are arranged in a horizontal direction. Accordingly, the left-view pictures marked as ‘Left’ are arranged in a row in a horizontal direction, the base-view pictures marked as ‘Center’ are arranged in a row in a horizontal direction, and the right-view pictures marked as ‘Right’ are arranged in a row in a horizontal direction. The base-view pictures may be center-view pictures compared to the left-view/right-view pictures.

In addition, pictures of the same picture order count (POC) order are arranged in a vertical direction. The POC order of the pictures indicates a reproduction order of pictures included in a video. ‘POC X’ marked in the multi-view video prediction structure indicates a relative reproduction order of pictures located in each column. A small value of X indicates an early reproduction order, and a large value thereof indicates a late reproduction order.

Therefore, based on the reproduction order 500 of the multi-view video prediction structure according to a related art, the left-view pictures marked as ‘Left’ are arranged based on the POC order (reproduction order) in a horizontal direction, the base-view pictures marked as ‘Center’ are arranged based on the POC order (reproduction order) in a horizontal direction, and the right-view pictures marked as ‘Right’ are arranged based on the POC order (reproduction order) in a horizontal direction. A left-view picture and a right-view picture located at the same column as a base-view picture have different views but have the same POC order (reproduction order).

Per view, four sequential pictures configure one group of pictures (GOP). Each GOP includes pictures located between two sequential anchor pictures, and one anchor picture (key picture).

An anchor picture is a random access point (RAP) picture. When a video is reproduced, at a certain reproduction order, that is, if a reproduction location is arbitrarily selected among the pictures arranged based on the POC order, an anchor picture which is the closest to the reproduction location in POC order is reproduced. The base-view pictures include base-view anchor pictures 511, 512, 513, 514, and 515, the left-view pictures include left-view anchor pictures 521, 522, 523, 524, and 525, and the right-view pictures include right-view anchor pictures 531, 532, 533, 534, and 535.

The multi-view pictures may be reproduced and predicted (reconstructed) in the order of the GOPs. Initially, according to the reproduction order 500 of the multi-view video prediction structure, per view, the pictures included in GOP 0 may be reproduced and then the pictures included in GOP 1 may be reproduced. That is, the pictures included in every GOP may be reproduced in the order of GOP 0, GOP 1, GOP 2, and GOP 3. In addition, based on a coding order of the multi-view video prediction structure, per view, the pictures included in GOP 0 may be predicted (reconstructed) and then the pictures included in GOP 1 may be predicted (reconstructed). That is, the pictures included in every GOP may be predicted (reconstructed) in the order of GOP 0, GOP 1, GOP 2, and GOP 3.

Based on the reproduction order 500 of the multi-view video prediction structure, both inter-view prediction (interlayer prediction) and inter prediction are performed on the pictures. In the multi-view video prediction structure, a picture from which an arrow starts is a reference picture, and a picture to which the arrow is directed is a picture to be predicted by using the reference picture.

A result of predicting the base-view pictures may be encoded and then output in the form of a base-view video stream, and a result of predicting the additional-view pictures may be encoded and then output in the form of a layer bitstream. In addition, a result of prediction-encoding the left-view pictures may be output in the form of a first layer bitstream, and a result of prediction-encoding the right-view pictures may be output in the form of a second layer bitstream

Only inter prediction is performed on the base-view pictures. That is, although the I-type anchor pictures 511, 512, 513, 514, and 515 do not refer to other pictures, the other B-type and b-type pictures are predicted with reference to other base-view pictures. The B-type pictures are predicted with reference to I-type anchor pictures preceding the same in POC order and I-type anchor pictures following the same in POC order. The b-type pictures are predicted with reference to I-type anchor pictures preceding the same in POC order and B-type pictures following the same in POC order, or with reference to B-type anchor pictures preceding the same in POC order and I-type anchor pictures following the same in POC order.

On the left-view pictures and the right-view pictures, inter-view prediction (interlayer prediction) is performed with reference to pictures of another view and inter prediction is performed with reference to pictures of the same view.

Inter-view prediction (interlayer prediction) may be performed on the left-view anchor pictures 521, 522, 523, 524, and 525 with reference to the base-view anchor pictures 511, 512, 513, 514, and 515 corresponding thereto in POC order. Inter-view prediction may be performed on the right-view anchor pictures 531, 532, 533, 534, and 535 with reference to the base-view anchor pictures 511, 512, 513, 514, and 515 or the left-view anchor pictures 521, 522, 523, 524, and 525 corresponding thereto in POC order. In addition, inter-view prediction (interlayer prediction) may be performed on left-view non-anchor pictures and right-view non-anchor pictures with reference to other-view pictures corresponding thereto in POC order.

The left-view non-anchor pictures and the right-view non-anchor pictures are predicted with reference to pictures of the same view.

However, the left-view pictures and the right-view pictures may not be predicted with reference to anchor pictures preceding the same in reproduction order among the additional-view pictures of the same view. That is, for inter prediction of a current left-view picture, left-view non-anchor pictures preceding the current left-view picture in reproduction order may be referred to. Likewise, for inter prediction of a current right-view picture, right-view non-anchor pictures preceding the current right-view picture in reproduction order may be referred to.

Alternatively, for inter prediction of a current left-view picture, a left-view picture belonging to a previous GOP preceding a current GOP including the current left-view picture may not be referred to, and a left-view picture belonging to the current GOP and preceding the current left-view picture in reconstruction order may be referred to. The above principle is equally applied to a right-view picture.

The video decoding apparatus 200 according to an embodiment may reconstruct the base-view pictures, the left-view pictures, and the right-view pictures based on the reproduction order 500 of the multi-view video prediction structure illustrated in FIG. 5.

The left-view pictures may be reconstructed by performing inter-view disparity compensation with reference to the base-view pictures and performing inter motion compensation with reference to the left-view pictures. The right-view pictures may be reconstructed by performing inter-view disparity compensation with reference to the base-view pictures and the left-view pictures and performing inter motion compensation with reference to the right-view pictures. Reference pictures should be reconstructed first for disparity compensation and motion compensation of the left-view pictures and the right-view pictures.

For inter motion compensation of the left-view picture, the left-view pictures may be reconstructed by performing inter motion compensation with reference to reconstructed left-view reference pictures. For inter motion compensation of the right-view picture, the right-view pictures may be reconstructed by performing inter motion compensation with reference to reconstructed right-view reference pictures.

Alternatively, for inter motion compensation of a current left-view picture, a left-view picture belonging to a previous GOP preceding a current GOP including the current left-view picture may not be referred to, and only a left-view picture belonging to the current GOP and preceding the current left-view picture in reconstruction order may be referred to. The above principle is equally applied to a right-view picture.

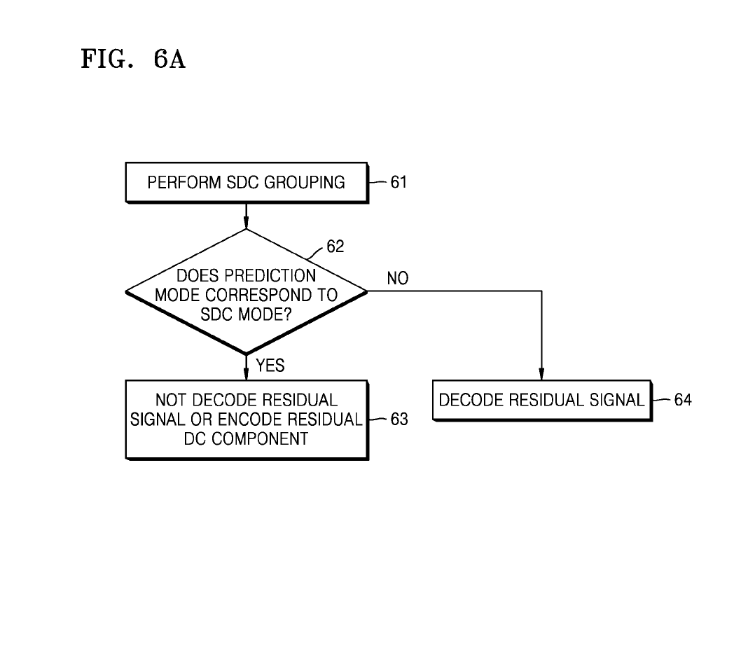

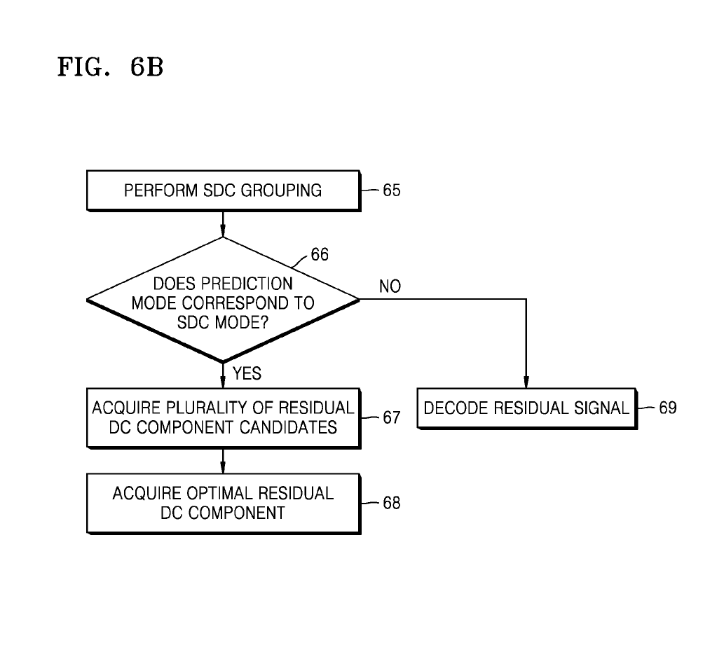

FIG. 6A is a flowchart of a method of differently encoding a residual block based on a prediction mode by an interlayer video encoding apparatus according to an embodiment.

In operation 61, the video encoding apparatus 100 may define some of predetermined partition modes as an SDC mode. For example, the video encoding apparatus 100 may configure a 2N×2N partition mode as the SDC mode. If the 2N×2N partition mode is configured as the SDC mode, the residual block may not be encoded or an average value of one or more of residual sample values of the residual block may be encoded, and thus encoding efficiency may be achieved.

In operation 62, the video encoding apparatus 100 determines whether the SDC mode is applied to a coding unit based on a partition mode of the coding unit. If the partition mode of the coding unit is configured as the SDC mode, the method proceeds to operation 63. Otherwise, if the partition mode is not configured as the SDC mode or if the configured partition mode is not configured as the SDC mode, the method proceeds to operation 64.

The video encoding apparatus 100 may determine whether the SDC mode is applied to the coding unit based on the partition mode of the coding unit, and generate SDC mode information indicating whether the SDC mode is applied to the coding unit.

In operation 63, the video encoding apparatus 100 may not encode a residual block or may encode the average value of one or more of residual sample values of the residual block. When the residual signal is not encoded, the video encoding apparatus 100 may operate in an inter mode similarly to a skip mode.

In operation 64, the video encoding apparatus 100 encodes the residual block by using a general encoding method. For example, discrete cosine transformation (DCT) and quantization may be sequentially performed on the residual block.

FIG. 6B is a flowchart of a method of differently encoding a residual block based on a prediction mode by an interlayer video encoding apparatus according to an embodiment.

In operation 65, the video encoding apparatus 100 may define some of predetermined partition modes as an SDC mode.

In operation 66, the video encoding apparatus 100 determines whether the SDC mode is applied to a coding unit based on a partition mode of the coding unit. If the partition mode is configured as the SDC mode, the method proceeds to operation 67. Otherwise, if the partition mode is not configured as the SDC mode or if the configured partition mode is not configured as the SDC mode, the method proceeds to operation 69.

In operation 67, the video encoding apparatus 100 may acquire an average value of one or more of residual sample values of a residual block. The video encoding apparatus 100 may acquire a plurality of residual DC value candidates by adding integer multiples of an offset value to the average value.

In operation 68, the video encoding apparatus 100 may determine an optimal residual DC value among the residual DC value candidates acquired in operation 67, based on rate-distortion optimization.

In operation 69, the video encoding apparatus 100 encodes the residual block by using a general encoding method.

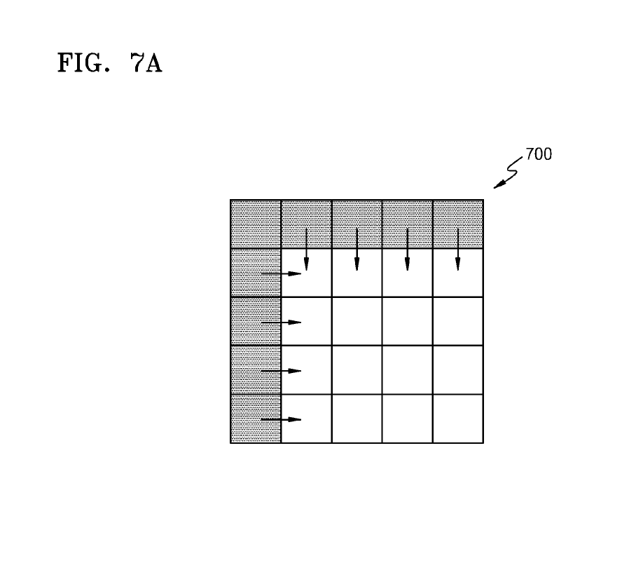

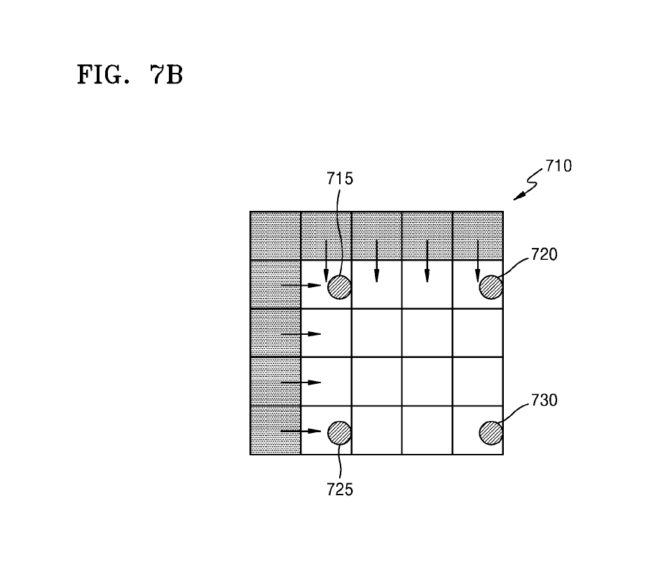

FIGS. 7A and 7B are diagrams for describing examples of generating residual data of a coding unit in a case when a prediction mode is an SDC mode, according to embodiments.

FIG. 7A shows a case when a residual block is not compressed. That is, if a small encoding error is predicted, the residual block having pixel values corresponding to errors between a current block and a reference block may not be compressed. In this case, the SDC mode may operate similarly to a skip mode.

FIG. 7B shows a case when an average value of four corner residual sample values of a residual block is determined as a residual DC value. Specifically, an average value of four pixels 715, 720, 725, and 730 of FIG. 7B is determined as the residual DC value.

Alternatively, an average value of four corner residual sample values and center residual sample values of the residual block may be determined as the residual DC value.

FIG. 8 illustrates a block diagram of a video encoding apparatus based on coding units of a tree structure 800, according to an embodiment of the present invention.

The video encoding apparatus involving video prediction based on coding units of the tree structure 800 includes a largest coding unit splitter 810, a coding unit determiner 820, and an output unit 830. Hereinafter, for convenience of description, the video encoding apparatus involving video prediction based on coding units of the tree structure 800 is referred to as the ‘video encoding apparatus 800’.

The largest coding unit splitter 810 may split a current picture based on a largest coding unit (maximum coding unit) that is a coding unit having a maximum size for a current picture of an image. If the current picture is larger than the largest coding unit, image data of the current picture may be split into the at least one largest coding unit. The largest coding unit according to an embodiment may be a data unit having a size of 32×32, 64×64, 128×128, 256×256, etc., wherein a shape of the data unit is a square having a width and length in squares of 2.

A coding unit according to an embodiment may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit may be defined as an uppermost depth and a depth of the smallest coding unit may be defined as a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to an embodiment is split according to depths, the image data of a spatial domain included in the largest coding unit may be hierarchically classified according to depths.

A maximum depth and a maximum size of a coding unit, which limit the total number of times a height and a width of the largest coding unit are hierarchically split, may be predetermined.

The coding unit determiner 820 encodes at least one split region obtained by splitting a region of the largest coding unit according to depths, and determines a depth to output a finally encoded image data according to the at least one split region. That is, the coding unit determiner 820 determines a final depth by encoding the image data in the deeper coding units according to depths, according to the largest coding unit of the current picture, and selecting a depth having the least encoding error. The determined final depth and image data according to largest coding units are output to the output unit 830.

The image data in the largest coding unit is encoded based on the deeper coding units corresponding to at least one depth equal to or below the maximum depth, and results of encoding the image data based on each of the deeper coding units are compared. A depth having the least encoding error may be selected after comparing encoding errors of the deeper coding units. At least one final depth may be selected for each largest coding unit.

The size of the largest coding unit is split as a coding unit is hierarchically split according to depths, and as the number of coding units increases. Even if coding units correspond to the same depth in one largest coding unit, it is also determined whether to split each of the coding units corresponding to the same depth to a lower depth by measuring an encoding error of the image data of the each coding unit, separately. Accordingly, even when image data is included in one largest coding unit, the encoding errors may differ according to regions in the one largest coding unit, and thus the final depths may differ according to regions in the image data. Thus, one or more final depths may be determined in one largest coding unit, and the image data of the largest coding unit may be divided according to coding units of at least one final depth.

Accordingly, the coding unit determiner 820 according to the embodiment may determine coding units having a tree structure included in the largest coding unit. The ‘coding units having a tree structure’ according to an embodiment include coding units corresponding to a depth determined to be the final depth, from among all deeper coding units included in the largest coding unit. A coding unit of a final depth may be hierarchically determined according to depths in the same region of the largest coding unit, and may be independently determined in different regions. Equally, a final depth in a current region may be determined independently from a final depth in another region.

A maximum depth according to an embodiment is an index related to the number of splitting times from a largest coding unit to a smallest coding unit. A first maximum depth according to an embodiment may denote the total number of splitting times from the largest coding unit to the smallest coding unit. A second maximum depth according to an embodiment may denote the total number of depth levels from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. Here, if the smallest coding unit is a coding unit in which the largest coding unit is split four times, depth levels of depths 0, 1, 2, 3, and 4 exist, and thus the first maximum depth may be set to 4, and the second maximum depth may be set to 5.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. Hereinafter, for convenience of description, the prediction encoding and the transformation will be described based on a coding unit of a current depth in at least one largest coding unit.

The video encoding apparatus 800 according to the embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 800 may select not only a coding unit for encoding the image data, but may also select a data unit different from the coding unit so as to perform the prediction encoding on the image data in the coding unit.

In order to perform prediction encoding in the largest coding unit, the prediction encoding may be performed based on a coding unit of a final depth, i.e., based on the coding unit that is no longer split. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one selected from a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode may selectively include symmetrical partitions obtained by symmetrically splitting a height or width of the prediction unit, and may selectively include partitions obtained by asymmetrically splitting the height or width of the prediction unit, such as 1:n or n:1, partitions obtained by geometrically splitting the prediction unit, and partitions having arbitrary shapes.

A prediction mode of the prediction unit may be at least one of an intra mode, an inter mode, and a skip mode. For example, the intra mode or the inter mode may be performed on the partition of 2N×2N, 2N×N, N×2N, or N×N. The skip mode may also be performed only on the partition of 2N×2N. The encoding may be independently performed on one prediction unit in a coding unit, thereby selecting a prediction mode having a least encoding error.

The video encoding apparatus 800 according to the embodiment may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the transformation unit may include a data unit for an intra mode and a transformation unit for an inter mode.

The transformation unit in the coding unit may be recursively split into smaller sized regions in the similar manner as the coding unit according to the tree structure, thus, residual data of the coding unit may be divided according to the transformation unit having the tree structure according to a transformation depth.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. That is, with respect to the transformation unit, the transformation unit having the tree structure may be set according to the transformation depths.

Split information according to depths requires not only information about a depth but also requires information related to prediction and transformation. Accordingly, the coding unit determiner 820 may determine not only a depth generating a least encoding error but may also determine a partition mode in which a prediction unit is split to partitions, a prediction mode according to prediction units, and a size of a transformation unit for transformation.

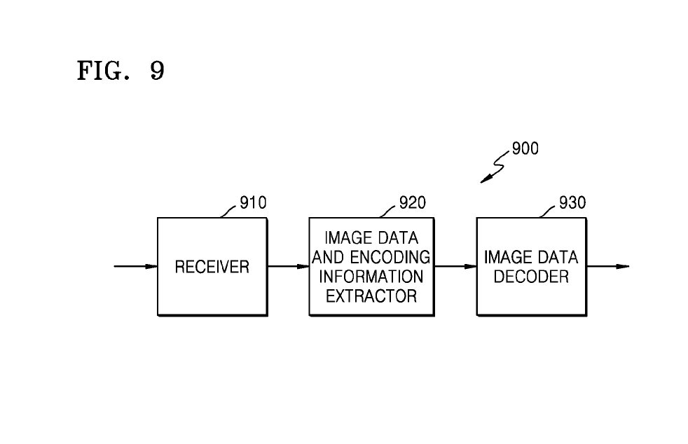

Coding units according to a tree structure in a largest coding unit and methods of determining a prediction unit/partition, and a transformation unit, according to embodiments, will be described in detail later with reference to FIGS. 9 through 19.

The coding unit determiner 820 may measure an encoding error of deeper coding units according to depths by using rate-distortion optimization based on Lagrangian multipliers.

The coding unit determiner 820 may perform functions of the residual block generator 110 and the residual DC value determiner 120 of FIG. 1A.

The coding unit determiner 820 may determine a coding unit and a prediction mode applied to the coding unit in consideration of a coding error of the coding unit per according to depths and a coding error of the coding unit according to prediction modes. The coding unit determiner 820 may predict a prediction unit of the coding unit according to the determined prediction mode to generate a residual block.

The coding unit determiner 820 may determine a residual DC value from residual pixel values of the generated residual block. The coding unit determiner 820 may determine a plurality of residual DC value candidates and determine a residual DC value candidate having a small coding error among the plurality of residual DC value candidates as the residual DC value.

The output unit 830 outputs, in bitstreams, the image data of the largest coding unit, which is encoded based on the at least one depth determined by the coding unit determiner 820, and information according to depths.

The encoded image data may correspond to a result obtained by encoding residual data of an image.

The split information according to depths may include depth information, partition mode information of the prediction unit, prediction mode information, and the split information of the transformation unit.

Final depth information may be defined by using split information according to depths, which specifies whether encoding is performed on coding units of a lower depth instead of a current depth. If the current depth of the current coding unit is a depth, the current coding unit is encoded by using the coding unit of the current depth, and thus split information of the current depth may be defined not to split the current coding unit to a lower depth. On the contrary, if the current depth of the current coding unit is not the depth, the encoding has to be performed on the coding unit of the lower depth, and thus the split information of the current depth may be defined to split the current coding unit to the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one largest coding unit, and at least one piece of split information has to be determined for a coding unit of a depth, at least one piece of split information may be determined for one largest coding unit. A depth of data of the largest coding unit may also vary according to locations since the data is hierarchically split according to depths, and thus a depth and split information may be set for the data.

Accordingly, the output unit 830 according to the embodiment may assign encoding information about a corresponding depth and an encoding mode to at least one of the coding unit, the prediction unit, and a minimum unit included in the largest coding unit.

The minimum unit according to an embodiment is a square data unit obtained by splitting the smallest coding unit constituting the lowermost depth by 4. Alternatively, the minimum unit according to an embodiment may be a maximum square data unit that may be included in all of the coding units, prediction units, partition units, and transformation units included in the largest coding unit.

For example, the encoding information output by the output unit 830 may be classified into encoding information according to deeper coding units, and encoding information according to prediction units. The encoding information according to the deeper coding units may include the information about the prediction mode and about the size of the partitions. The encoding information according to the prediction units may include information about an estimated direction during an inter mode, about a reference image index of the inter mode, about a motion vector, about a chroma value of an intra mode, and about an interpolation method during the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit allowed with respect to a current video, and information about a minimum size of the transformation unit may also be output through a header of a bitstream, a sequence parameter set, or a picture parameter set. The output unit 830 may encode and output reference information, prediction information, and slice type information, which are related to prediction.

The output unit 830 may perform functions of the residual DC value determiner 130, the coding unit information determiner 140, the SDC flag determiner 150, and the bitstream determiner 160 of FIG. 1A.

The output unit 830 may determine information regarding a prediction mode and a partition mode used to predict the coding unit.

The output unit 830 may determine an SDC flag indicating whether the coding unit is encoded by an SDC mode.

The output unit 830 may determine SDC mode information with respect to a depth image according to whether a coding unit in which the SDC mode is used is present in the depth image.

The output unit 830 may output a bitstream including the residual DC value, prediction mode information, partition mode information, the SDC flag, and the SDC mode information.

According to the simplest embodiment for the video encoding apparatus 800, the deeper coding unit may be a coding unit obtained by dividing a height or width of a coding unit of an upper depth, which is one layer above, by two. That is, when the size of the coding unit of the current depth is 2N×2N, the size of the coding unit of the lower depth is N×N. A current coding unit having a size of 2N×2N may also maximally include four lower-depth coding units having a size of N×N.

Accordingly, the video encoding apparatus 800 may form the coding units having the tree structure by determining coding units having an optimum shape and an optimum size for each largest coding unit, based on the size of the largest coding unit and the maximum depth determined considering characteristics of the current picture. Since encoding may be performed on each largest coding unit by using any one of various prediction modes and transformations, an optimal encoding mode may also be determined by taking into account characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus according to the embodiment, image compression efficiency may be increased since a coding unit is adjusted while considering characteristics of an image while increasing a maximum size of a coding unit while considering a size of the image.

The inter-layer video encoding apparatus including configuration described above with reference to FIG. 1A may include the video encoding apparatuses 800 corresponding to the number of layers so as to encode single layer images in each of the layers of a multilayer video. For example, a first layer encoder may include one video encoding apparatus 800, and a second layer encoder may include the video encoding apparatuses 800 corresponding to the number of second layers.

When the video encoding apparatuses 800 encode first layer images, the coding unit determiner 820 may determine a prediction unit for inter-image prediction according to each of coding units of a tree structure in each largest coding unit, and may perform the inter-image prediction on each prediction unit.

When the video encoding apparatuses 800 encode the second layer images, the coding unit determiner 820 may determine prediction units and coding units of a tree structure in each largest coding unit, and may perform inter-prediction on each of the prediction units.

The video encoding apparatuses 800 may encode a luminance difference so as to compensate for the luminance difference between the first layer image and the second layer image. However, whether to perform luminance compensation may be determined according to an encoding mode of a coding unit. For example, the luminance compensation may be performed only on a prediction unit having a size of 2N×2N.

FIG. 9 illustrates a block diagram of a video decoding apparatus based on coding units of a tree structure 900, according to an embodiment.

The video decoding apparatus involving video prediction based on coding units of the tree structure 900 according to the embodiment includes a receiver 910, an image data and encoding information extractor 920, and an image data decoder 930. Hereinafter, for convenience of description, the video decoding apparatus involving video prediction based on coding units of the tree structure 900 according to the embodiment is referred to as the ‘video decoding apparatus 900’.

Definitions of various terms, such as a coding unit, a depth, a prediction unit, a transformation unit, and various types of split information for decoding operations of the video decoding apparatus 900 according to the embodiment are identical to those described with reference to FIG. 8 and the video encoding apparatus 800.

The receiver 910 receives and parses a bitstream of an encoded video. The image data and encoding information extractor 920 extracts encoded image data for each coding unit from the parsed bitstream, wherein the coding units have a tree structure according to each largest coding unit, and outputs the extracted image data to the image data decoder 930. The image data and encoding information extractor 920 may extract information about a maximum size of a coding unit of a current picture, from a header about the current picture, a sequence parameter set, or a picture parameter set.

The image data and encoding information extractor 920 also extracts, from the parsed bitstream, a final depth and split information about the coding units having a tree structure according to each largest coding unit. The extracted final depth and the extracted split information are output to the image data decoder 930. That is, the image data in a bitstream is split into the largest coding unit so that the image data decoder 930 may decode the image data for each largest coding unit.

A depth and split information according to each of the largest coding units may be set for one or more pieces of depth information, and split information according to depths may include partition mode information of a corresponding coding unit, prediction mode information, and split information of a transformation unit. As the depth information, the split information according to depths may also be extracted.

The depth and the split information according to each of the largest coding units extracted by the image data and encoding information extractor 920 are a depth and split information determined to generate a minimum encoding error when an encoder, such as the video encoding apparatus 800, repeatedly performs encoding for each deeper coding unit according to depths according to each largest coding unit. Accordingly, the video decoding apparatus 900 may reconstruct an image by decoding data according to an encoding method that generates the minimum encoding error.

Since encoding information about the depth and the encoding mode may be assigned to a predetermined data unit from among a corresponding coding unit, a prediction unit, and a minimum unit, the image data and encoding information extractor 920 may extract the depth and the split information according to the predetermined data units. If a depth and split information of a corresponding largest coding unit are recorded according to each of the predetermined data units, predetermined data units having the same depth and the split information may be inferred to be the data units included in the same largest coding unit.

The image data and encoding information extractor 920 may perform functions of the SDC mode information acquirer 210, the coding unit information determiner 220, the SDC flag acquirer 230, and the residual DC value acquirer 240 of FIG. 2A.

The image data and encoding information extractor 920 may acquire SDC mode information and determine whether an SDC mode is allowed in a depth image from the SDC mode information.

The image data and encoding information extractor 920 may acquire information regarding a prediction mode and a partition mode of a coding unit.

The image data and encoding information extractor 920 may acquire an SDC flag with respect to the coding unit when the SDC mode is allowed in the depth image.

The image data and encoding information extractor 920 may acquire a residual DC value with respect to the coding unit when the SDC flag indicates that the SDC mode is applied to the coding unit.

The image data decoder 930 reconstructs the current picture by decoding the image data in each largest coding unit based on the depth and the split information according to each of the largest coding units. That is, the image data decoder 930 may decode the encoded image data, based on a read partition mode, a prediction mode, and a transformation unit for each coding unit from among the coding units having the tree structure included in each largest coding unit. A decoding process may include a prediction process including intra prediction and motion compensation, and an inverse transformation process.

The image data decoder 930 may perform intra prediction or motion compensation according to a partition and a prediction mode of each coding unit, based on the information about the partition type and the prediction mode of the prediction unit of the coding unit according to depths.

In addition, for inverse transformation for each largest coding unit, the image data decoder 930 may read information about a transformation unit according to a tree structure for each coding unit so as to perform inverse transformation based on transformation units for each coding unit. Due to the inverse transformation, a pixel value of a spatial domain of the coding unit may be reconstructed.

The image data decoder 930 may determine a depth of a current largest coding unit by using split information according to depths. If the split information indicates that image data is no longer split in the current depth, the current depth is a depth. Accordingly, the image data decoder 930 may decode the image data of the current largest coding unit by using the information about the partition mode of the prediction unit, the prediction mode, and the size of the transformation unit for each coding unit corresponding to the current depth.

That is, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 930 in the same encoding mode. As such, the current coding unit may be decoded by obtaining the information about the encoding mode for each coding unit.

The image data decoder 930 may perform a function of the decoder 250 of FIG. 2A.

The image data decoder 930 may determine prediction values included in a prediction unit of the coding unit according to the prediction mode and the partition mode of the coding unit. The image data decoder 930 may add the residual DC value to each of the prediction values to reconstruct a current block of the coding unit.

The inter-layer video decoding apparatus including configuration described above with reference to FIG. 2A may include the video decoding apparatuses 900 corresponding to the number of views, so as to reconstruct first layer images and second layer images by decoding a received first layer image stream and a received second layer image stream.

When the first layer image stream is received, the image data decoder 930 of the video decoding apparatus 900 may split samples of the first layer images, which are extracted from the first layer image stream by an extractor 920, into coding units according to a tree structure of a largest coding unit. The image data decoder 930 may perform motion compensation, based on prediction units for the inter-image prediction, on each of the coding units according to the tree structure of the samples of the first layer images, and may reconstruct the first layer images.

When the second layer image stream is received, the image data decoder 930 of the video decoding apparatus 900 may split samples of the second layer images, which are extracted from the second layer image stream by the extractor 920, into coding units according to a tree structure of a largest coding unit. The image data decoder 930 may perform motion compensation, based on prediction units for the inter-image prediction, on each of the coding units of the samples of the second layer images, and may reconstruct the second layer images.

The extractor 920 may obtain, from a bitstream, information related to a luminance error so as to compensate for a luminance difference between the first layer image and the second layer image. However, whether to perform luminance compensation may be determined according to an encoding mode of a coding unit. For example, the luminance compensation may be performed only on a prediction unit having a size of 2N×2N.

Thus, the video decoding apparatus 900 may obtain information about at least one coding unit that generates the minimum encoding error when encoding is recursively performed for each largest coding unit, and may use the information to decode the current picture. That is, the coding units having the tree structure determined to be the optimum coding units in each largest coding unit may be decoded.

Accordingly, even if an image has high resolution or has an excessively large data amount, the image may be efficiently decoded and reconstructed according to a size of a coding unit and an encoding mode that are adaptively determined according to characteristics of the image, by using optimal split information received from an encoding terminal.

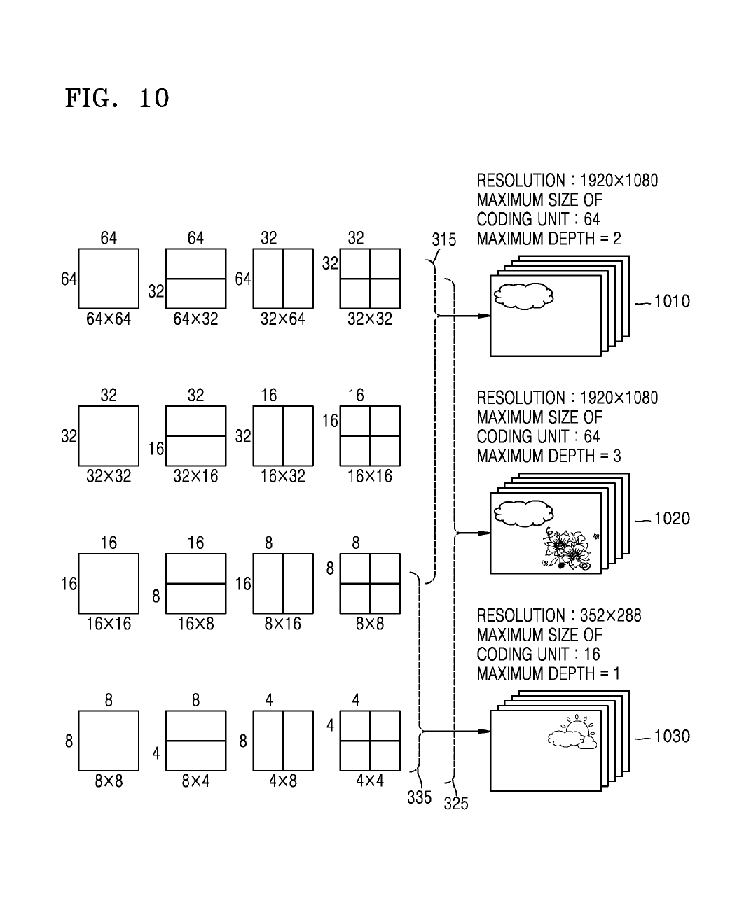

FIG. 10 illustrates a concept of coding units, according to an embodiment.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 1010, a resolution is 1920×1080, a maximum size of a coding unit is 64, and a maximum depth is 2. In video data 1020, a resolution is 1920×1080, a maximum size of a coding unit is 64, and a maximum depth is 3. In video data 1030, a resolution is 352×288, a maximum size of a coding unit is 16, and a maximum depth is 1. The maximum depth shown in FIG. 10 denotes the total number of splits from a largest coding unit to a smallest coding unit.

If a resolution is high or a data amount is large, it is preferable that a maximum size of a coding unit is large so as to not only increase encoding efficiency but also to accurately reflect characteristics of an image. Accordingly, the maximum size of the coding unit of the video data 1010 and 1020 having a higher resolution than the video data 1030 may be selected to 64.

Since the maximum depth of the video data 1010 is 2, coding units 1015 of the vide data 1010 may include a largest coding unit having a long axis size of 64, and coding units having long axis sizes of 32 and 16 since depths are deepened to two layers by splitting the largest coding unit twice. On the other hand, since the maximum depth of the video data 1030 is 1, coding units 1035 of the video data 1030 may include a largest coding unit having a long axis size of 16, and coding units having a long axis size of 8 since depths are deepened to one layer by splitting the largest coding unit once.

Since the maximum depth of the video data 1020 is 3, coding units 1025 of the video data 1020 may include a largest coding unit having a long axis size of 64, and coding units having long axis sizes of 32, 16, and 8 since the depths are deepened to 3 layers by splitting the largest coding unit three times. As a depth deepens, an expression capability with respect to detailed information may be improved.

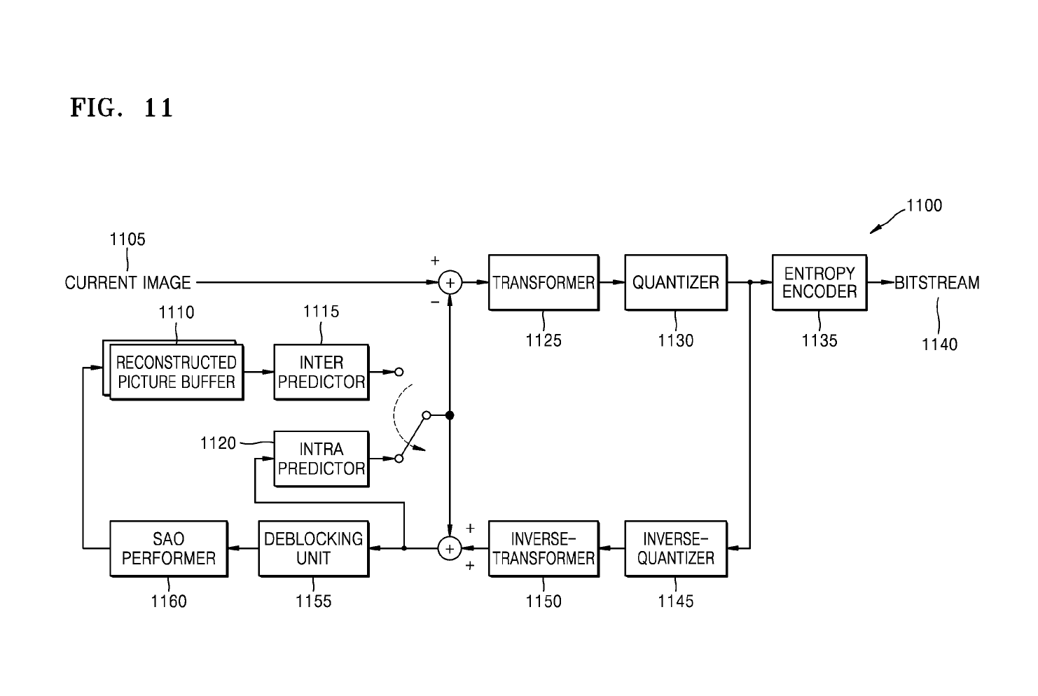

FIG. 11 illustrates a block diagram of a video encoder 1100 based on coding units, according to various embodiments.

The video encoder 1100 according to an embodiment performs operations of a picture encoder 1520 of the video encoding apparatus 800 so as to encode image data. That is, an intra predictor 1120 performs intra prediction on coding units in an intra mode, from among a current image 1105, and an inter predictor 1115 performs inter prediction on coding units in an inter mode by using the current image 1105 and a reference image obtained from a reconstructed picture buffer 1110 according to prediction units. The current image 1105 may be split into largest coding units and then the largest coding units may be sequentially encoded. In this regard, the largest coding units that are to be split into coding units having a tree structure may be encoded.

Residue data is generated by removing prediction data regarding a coding unit of each mode which is output from the intra predictor 1120 or the inter predictor 1115 from data regarding an encoded coding unit of the current image 1105, and the residue data is output as a quantized transformation coefficient according to transformation units through a transformer 1125 and a quantizer 1130. The quantized transformation coefficient is reconstructed as the residue data in a spatial domain through an inverse-quantizer 1145 and an inverse-transformer 1150. The reconstructed residual image data in the spatial domain is added to prediction data for the coding unit of each mode which is output from the intra predictor 1120 or the inter predictor 1115 and thus is reconstructed as data in a spatial domain for a coding unit of the current image 1105. The reconstructed data in the spatial domain is generated as a reconstructed image through a deblocking unit 1155 and an SAO performer 1160 and the reconstructed image is stored in the reconstructed picture buffer 1110. The reconstructed images stored in the reconstructed picture buffer 1110 may be used as reference images for inter predicting another image. The transformation coefficient quantized by the transformer 1125 and the quantizer 1130 may be output as a bitstream 1140 through an entropy encoder 1135.

In order for the video encoder 1100 to be applied in the video encoding apparatus 800, all elements of the video encoder 1100, i.e., the inter predictor 1115, the intra predictor 1120, the transformer 1125, the quantizer 1130, the entropy encoder 1135, the inverse-quantizer 1145, the inverse-transformer 1150, the deblocking unit 1155, and the SAO performer 1160, may perform operations based on each coding unit among coding units having a tree structure according to each largest coding unit.

In particular, the intra predictor 1120 and the inter predictor 1115 may determine a partition mode and a prediction mode of each coding unit from among the coding units having a tree structure, by taking into account the maximum size and the maximum depth of a current largest coding unit, and the transformer 1125 may determine whether to split a transformation unit according to a quadtree in each coding unit from among the coding units having a tree structure.

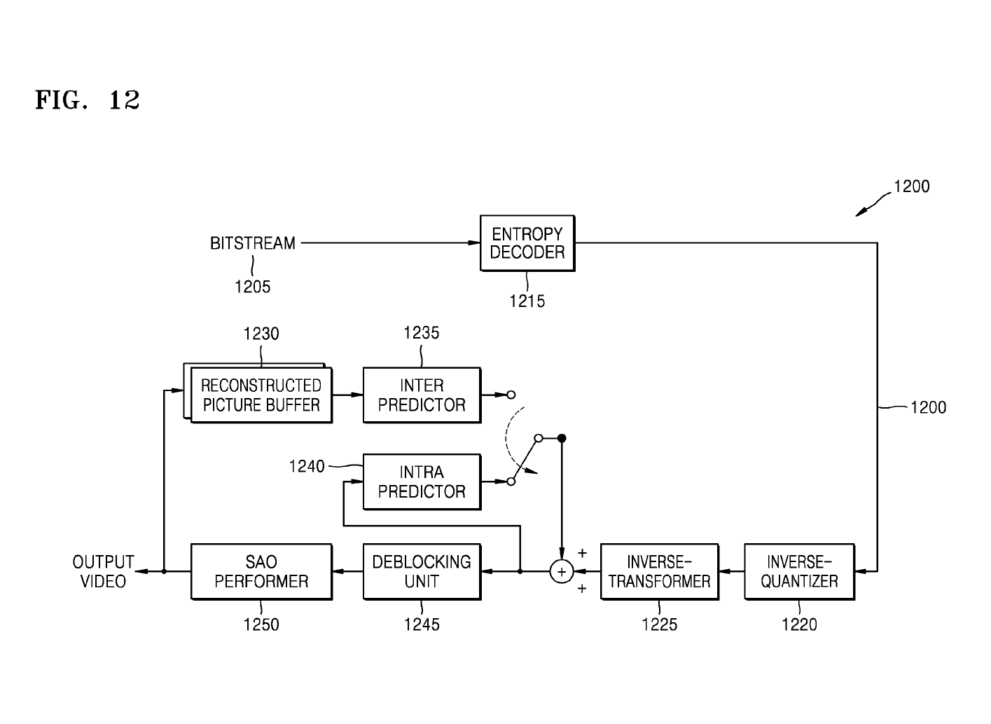

FIG. 12 illustrates a block diagram of a video decoder 1200 based on coding units, according to an embodiment.

An entropy decoder 1215 parses, from a bitstream 1205, encoded image data to be decoded and encoding information required for decoding. The encoded image data corresponds to a quantized transformation coefficient, and an inverse-quantizer 1220 and an inverse-transformer 1225 reconstruct residue data from the quantized transformation coefficient.

An intra predictor 1240 performs intra prediction on a coding unit in an intra mode according to prediction units. An inter predictor 1235 performs inter prediction by using a reference image with respect to a coding unit in an inter mode from among a current image, wherein the reference image is obtained by a reconstructed picture buffer 1230 according to prediction units.

Prediction data and residue data regarding coding units of each mode, which passed through the intra predictor 1240 and the inter predictor 1235, are summed, so that data in a spatial domain regarding coding units of the current image 1205 may be reconstructed, and the reconstructed data in the spatial domain may be output as a reconstructed image 1260 through a deblocking unit 1245 and an SAO performer 1250. Reconstructed images stored in the reconstructed picture buffer 30 may also be output as reference images.

In order for a picture decoder 930 of the video decoding apparatus 900 to decode the image data, operations after the entropy decoder 1215 of the video decoder 1200 according to an embodiment may be performed.

In order for the video decoder 1200 to be applied in the video decoding apparatus 900 according to an embodiment, all elements of the video decoder 1200, i.e., the entropy decoder 1215, the inverse-quantizer 1220, the inverse-transformer 1225, the intra predictor 1240, the inter predictor 1235, the deblocking unit 1245, and the SAO performer 1250 may perform operations based on coding units having a tree structure for each largest coding unit.

In particular, the intra predictor 1240 and the inter predictor 1235 may determine a partition mode and a prediction mode of each coding unit from among the coding units according to a tree structure, and the inverse-transformer 1225 may determine whether or not to split a transformation unit according to a quadtree in each coding unit.

The encoding operation of FIG. 10 and the decoding operation of FIG. 11 are described as a videostream encoding operation and a videostream decoding operation, respectively, in a single layer. Thus, if the video encoding apparatus 10 of FIG. 1A encodes a videostream of two or more layers, the video encoder 1100 may be provided for each layer. Similarly, if the inter-layer decoding apparatus 20 of FIG. 2A decodes a videostream of two or more layers, the video decoder 1200 may be provided for each layer.

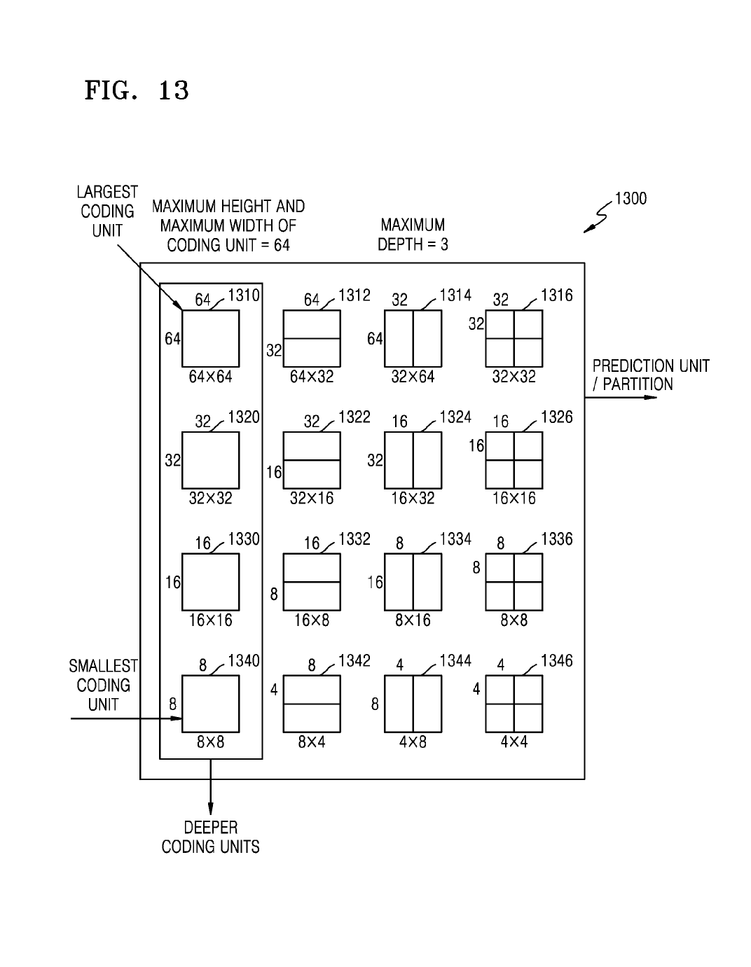

FIG. 13 illustrates deeper coding units according to depths, and partitions, according to an embodiment.

The video encoding apparatus 800 according to an embodiment and the video decoding apparatus 900 according to an embodiment use hierarchical coding units so as to consider characteristics of an image. A maximum height, a maximum width, and a maximum depth of coding units may be adaptively determined according to the characteristics of the image, or may be variously set according to user requests. Sizes of deeper coding units according to depths may be determined according to the predetermined maximum size of the coding unit.

In a hierarchical structure of coding units 1300 according to an embodiment, the maximum height and the maximum width of the coding units are each 64, and the maximum depth is 3. In this case, the maximum depth represents a total number of times the coding unit is split from the largest coding unit to the smallest coding unit. Since a depth deepens along a vertical axis of the hierarchical structure of coding units 1300, a height and a width of the deeper coding unit are each split. A prediction unit and partitions, which are bases for prediction encoding of each deeper coding unit, are also shown along a horizontal axis of the hierarchical structure of coding units 1300.

That is, a coding unit 1310 is a largest coding unit in the hierarchical structure of coding units 1300, wherein a depth is 0 and a size, i.e., a height by width, is 64×64. The depth deepens along the vertical axis, and a coding unit 1320 having a size of 32×32 and a depth of 1, a coding unit 1330 having a size of 16×16 and a depth of 2, and a coding unit 1340 having a size of 8×8 and a depth of 3. The coding unit 1340 having the size of 8×8 and the depth of 3 is a smallest coding unit.

The prediction unit and the partitions of a coding unit are arranged along the horizontal axis according to each depth. That is, if the coding unit 1310 having a size of 64×64 and a depth of 0 is a prediction unit, the prediction unit may be split into partitions include in the coding unit 1310 having the size of 64×64, i.e. a partition 1310 having a size of 64×64, partitions 1312 having the size of 64×32, partitions 1314 having the size of 32×64, or partitions 1316 having the size of 32×32.

Equally, a prediction unit of the coding unit 1320 having the size of 32×32 and the depth of 1 may be split into partitions included in the coding unit 1320 having the size of 32×32, i.e. a partition 1320 having a size of 32×32, partitions 1322 having a size of 32×16, partitions 1324 having a size of 16×32, and partitions 1326 having a size of 16×16.

Equally, a prediction unit of the coding unit 1330 having the size of 16×16 and the depth of 2 may be split into partitions included in the coding unit 1330 having the size of 16×16, i.e. a partition 1330 having a size of 16×16 included in the coding unit 1330, partitions 1332 having a size of 16×8, partitions 1334 having a size of 8×16, and partitions 1336 having a size of 8×8.

Equally, a prediction unit of the coding unit 1340 having the size of 8×8 and the depth of 3 may be split into partitions included in the coding unit 1340 having the size of 8×8, i.e. a partition 1340 having a size of 8×8 included in the coding unit 1340, partitions 1342 having a size of 8×4, partitions 1344 having a size of 4×8, and partitions 1346 having a size of 4×4.

In order to determine a depth of the largest coding unit 1310, the coding unit determiner 820 of the video encoding apparatus 800 has to perform encoding on coding units respectively corresponding to depths included in the largest coding unit 1310.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare results of encoding the same data according to depths, the data has to be encoded by using each of the coding unit corresponding to the depth of 1 and four coding units corresponding to the depth of 2.

In order to perform encoding according to each of the depths, a least encoding error that is a representative encoding error of a corresponding depth may be selected by performing encoding on each of prediction units of the coding units according to depths, along the horizontal axis of the hierarchical structure of coding units 1300. The minimum encoding error may also be searched for by comparing representative encoding errors according to depths, by performing encoding for each depth as the depth deepens along the vertical axis of the hierarchical structure of coding units 1300. A depth and a partition generating the minimum encoding error in the largest coding unit 1310 may be selected as a depth and a partition mode of the largest coding unit 1310.

FIG. 14 illustrates a relationship between a coding unit and transformation units, according to an embodiment.

The video encoding apparatus 800 according to an embodiment or the video decoding apparatus 900 according to an embodiment encodes or decodes an image according to coding units having sizes smaller than or equal to a largest coding unit for each largest coding unit. Sizes of transformation units for transformation during an encoding process may be selected based on data units that are not larger than a corresponding coding unit.

For example, in the video encoding apparatus 800 or the video decoding apparatus 900, when a size of the coding unit 1410 is 64×64, transformation may be performed by using the transformation units 1420 having a size of 32×32.

Data of the coding unit 1410 having the size of 64×64 may also be encoded by performing the transformation on each of the transformation units having the size of 32×32, 16×16, 8×8, and 4×4, which are smaller than 64×64, and then a transformation unit having the least coding error with respect to an original image may be selected.

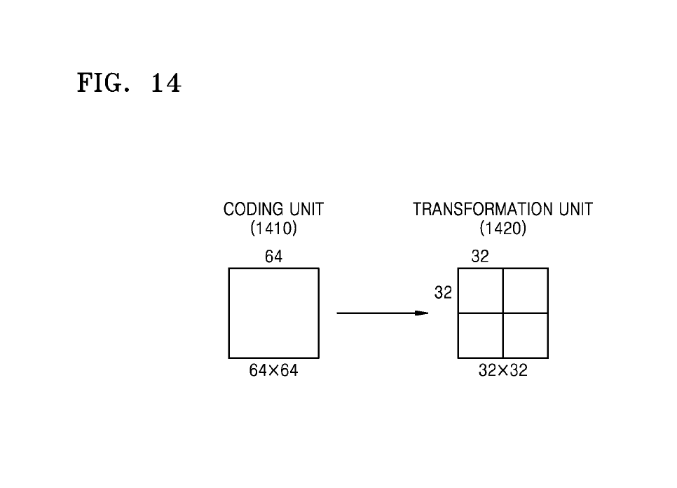

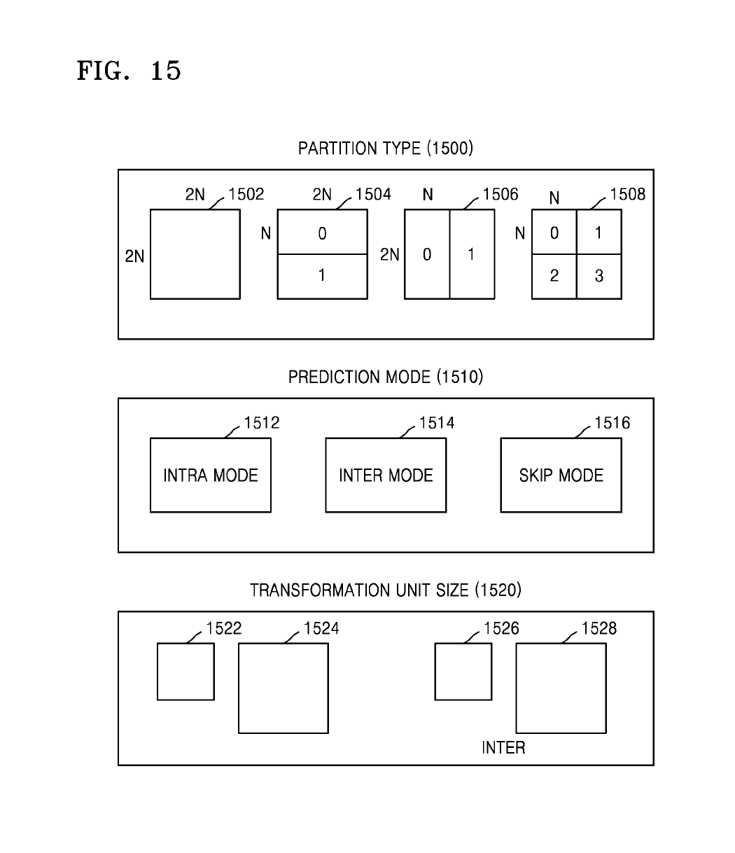

FIG. 15 illustrates a plurality of pieces of encoding information, according to an embodiment.

The output unit 830 of the video encoding apparatus 800 according to an embodiment may encode and transmit, as split information, partition mode information 1500, prediction mode information 1510, and transformation unit size information 1520 for each coding unit corresponding to a depth.

The partition mode information 1500 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 1502 having a size of 2N×2N, a partition 1504 having a size of 2N×N, a partition 1506 having a size of N×2N, and a partition 1508 having a size of N×N. In this case, the partition mode information 1500 about a current coding unit is set to indicate one of the partition 1502 having a size of 2N×2N, the partition 1504 having a size of 2N×N, the partition 1506 having a size of N×2N, and the partition 1508 having a size of N×N.

The prediction mode information 1510 indicates a prediction mode of each partition. For example, the prediction mode information 1510 may indicate a mode of prediction encoding performed on a partition indicated by the partition mode information 1500, i.e., an intra mode 1512, an inter mode 1514, or a skip mode 1516.

The transformation unit size information 1520 represents a transformation unit to be based on when transformation is performed on a current coding unit. For example, the transformation unit may be one of a first intra transformation unit 1522, a second intra transformation unit 1524, a first inter transformation unit 1526, and a second inter transformation unit 1528.

The image data and encoding information extractor 1610 of the video decoding apparatus 900 may extract and use the partition mode information 1500, the prediction mode information 1510, and the transformation unit size information 1520 for decoding, according to each deeper coding unit.

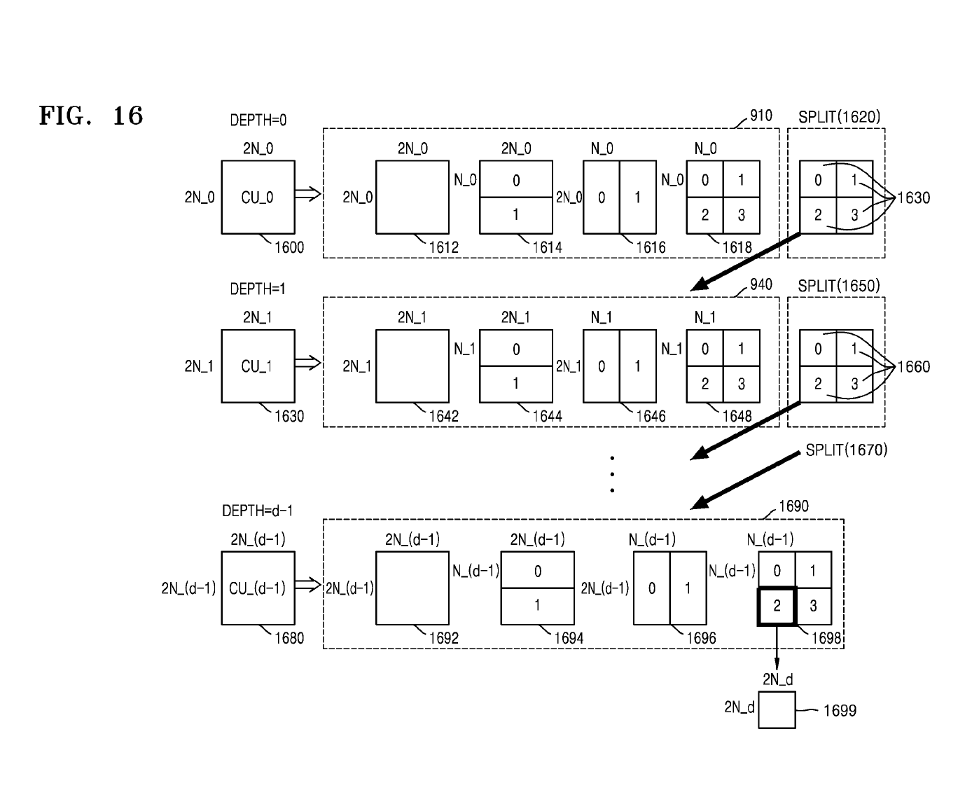

FIG. 16 illustrates deeper coding units according to depths, according to an embodiment.

Split information may be used to represent a change in a depth. The spilt information specifies whether a coding unit of a current depth is split into coding units of a lower depth.

A prediction unit 1610 for prediction encoding a coding unit 1600 having a depth of 0 and a size of 2N_0×2N_0 may include partitions of a partition mode 1612 having a size of 2N_0×2N_0, a partition mode 1614 having a size of 2N_0×N_0, a partition mode 1616 having a size of N_0×2N_0, and a partition mode 1618 having a size of N_0×N_0. Only the partition modes 1612, 1614, 1616, and 1618 which are obtained by symmetrically splitting the prediction unit are illustrated, but as described above, a partition mode is not limited thereto and may include asymmetrical partitions, partitions having a predetermined shape, and partitions having a geometrical shape.

According to each partition mode, prediction encoding has to be repeatedly performed on one partition having a size of 2N_0×2N_0, two partitions having a size of 2N_0×N_0, two partitions having a size of N_0×2N_0, and four partitions having a size of N_0×N_0. The prediction encoding in an intra mode and an inter mode may be performed on the partitions having the sizes of 2N_0×2N_0, N_0×2N_0, 2N_0×N_0, and N_0×N_0. The prediction encoding in a skip mode may be performed only on the partition having the size of 2N_0×2N_0.

If an encoding error is smallest in one of the partition modes 1612, 1614, and 1616 having the sizes of 2N_0×2N_0, 2N_0×N_0 and N_0×2N_0, the prediction unit 1610 may not be split into a lower depth.

If the encoding error is the smallest in the partition mode 1618 having the size of N_0×N_0, a depth is changed from 0 to 1 and split is performed (operation 1620), and encoding may be repeatedly performed on coding units 1630 of a partition mode having a depth of 2 and a size of N_0×N_0 so as to search for a minimum encoding error.

A prediction unit 1630 for prediction encoding the coding unit 1630 having a depth of 1 and a size of 2N_1×2N_1 (=N_0×N_0) may include a partition mode 1642 having a size of 2N_1×2N_1, a partition mode 1644 having a size of 2N_1×N_1, a partition mode 1646 having a size of N_1×2N_1, and a partition mode 1648 having a size of N_1×N_1.

If an encoding error is the smallest in the partition mode 1648 having the size of N_1×N_1, a depth is changed from 1 to 2 and split is performed (in operation 1650), and encoding is repeatedly performed on coding units 1660 having a depth of 2 and a size of N_2×N_2 so as to search for a minimum encoding error.

When a maximum depth is d, deeper conding units according to depths may be set until when a depth corresponds to d−1, and split information may be set until when a depth corresponds to d−2. That is, when encoding is performed up to when the depth is d−1 after a coding unit corresponding to a depth of d−2 is split (in operation 1670), a prediction unit 1690 for prediction encoding a coding unit 1680 having a depth of d−1 and a size of 2N_(d−1)×2N_(d−1) may include partitions of a partition mode 1692 having a size of 2N_(d−1)×2N_(d−1), a partition mode 1694 having a size of 2N_(d−1)×N_(d−1), a partition mode 1696 having a size of N_(d−1)×2N_(d−1), and a partition mode 1698 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes so as to search for a partition mode generating a minimum encoding error.

Even when the partition type 1698 having the size of N_(d−1)×N_(d−1) has the minimum encoding error, since a maximum depth is d, a coding unit CU_(d−1) having a depth of d−1 is no longer split into a lower depth, and a depth for the coding units constituting a current largest coding unit 1600 is determined to be d−1 and a partition mode of the current largest coding unit 1600 may be determined to be N_(d−1)×N_(d−1). Since the maximum depth is d, split information for a coding unit 1652 corresponding to a depth of d−1 is not also set.

A data unit 1699 may be a ‘minimum unit’ for the current largest coding unit. A minimum unit according to the embodiment may be a square data unit obtained by splitting a smallest coding unit having a lowermost depth by 4. By performing the encoding repeatedly, the video encoding apparatus 800 according to the embodiment may select a depth having the least encoding error by comparing encoding errors according to depths of the coding unit 1600 to determine a depth, and set a corresponding partition type and a prediction mode as an encoding mode of the depth.

As such, the minimum encoding errors according to depths are compared in all of the depths of 0, 1, . . . , d−1, d, and a depth having the least encoding error may be determined as a depth. The depth, the partition mode of the prediction unit, and the prediction mode may be encoded and transmitted as split information. Since a coding unit has to be split from a depth of 0 to a depth, only split information of the depth is also set to ‘0’, and split information of depths excluding the depth is also set to ‘1’.

The image data and encoding information extractor 920 of the video decoding apparatus 900 according to the embodiment may extract and use a depth and prediction unit information about the coding unit 1600 so as to decode the coding unit 1612. The video decoding apparatus 900 according to the embodiment may determine a depth, in which split information is ‘0’, as a depth by using split information according to depths, and may use, for decoding, split information about the corresponding depth.

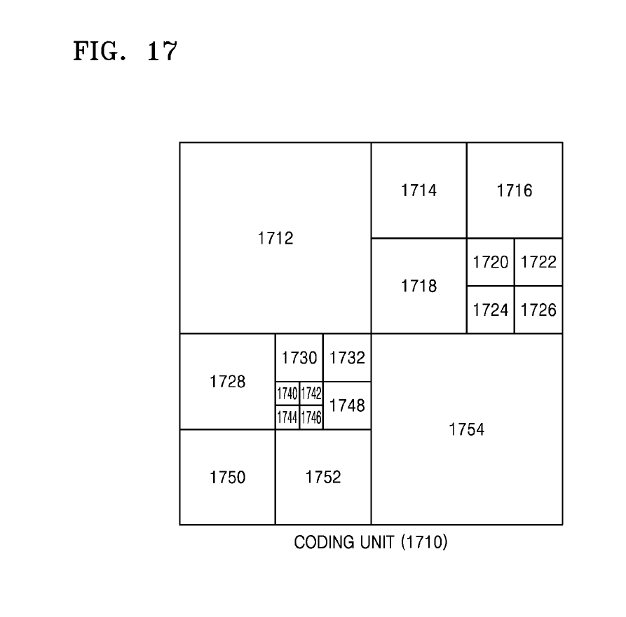

FIGS. 17, 18, and 19 illustrate a relationship between coding units, prediction units, and transformation units, according to an embodiment.

Coding units 1710 are deeper coding units according to depths determined by the video encoding apparatus 800, in a largest coding unit. Prediction units 1760 are partitions of prediction units of each of the coding units 1710 according to depths, and transformation units 1770 are transformation units of each of the coding units according to depths.

When a depth of a largest coding unit is 0 in the deeper coding units 1710, depths of coding units 1712 and 1054 are 1, depths of coding units 1714, 1716, 1718, 1728, 1750, and 1752 are 2, depths of coding units 1720, 1722, 1724, 1726, 1730, 1732, and 1748 are 3, and depths of coding units 1740, 1742, 1744, and 1746 are 4.

Some partitions 1714, 1716, 1722, 1732, 1748, 1750, 1752, and 1754 from among the prediction units 1760 are obtained by splitting the coding unit. That is, partitions 1714, 1722, 1750, and 1754 are a partition mode having a size of 2N×N, partitions 1716, 1748, and 1752 are a partition mode having a size of N×2N, and a partition 1732 is a partition mode having a size of N×N. Prediction units and partitions of the deeper coding units 1710 are smaller than or equal to each coding unit.

Transformation or inverse transformation is performed on image data of the coding unit 1752 in the transformation units 1770 in a data unit that is smaller than the coding unit 1752. The coding units 1714, 1716, 1722, 1732, 1748, 1750, 1752, and 1754 in the transformation units 1760 are also data units different from those in the prediction units 1760 in terms of sizes or shapes. That is, the video encoding apparatus 800 and the video decoding apparatus 900 according to the embodiments may perform intra prediction/motion estimation/motion compensation/and transformation/inverse transformation on an individual data unit in the same coding unit.

Accordingly, encoding is recursively performed on each of coding units having a hierarchical structure in each region of a largest coding unit so as to determine an optimum coding unit, and thus coding units according to a recursive tree structure may be obtained. Encoding information may include split information about a coding unit, partition mode information, prediction mode information, and transformation unit size information. Table 1 below shows the encoding information that may be set by the video encoding apparatus 800 and the video decoding apparatus 900 according to the embodiments.

TABLE 1

| Split Information 0 | | | | | |
|---|---|---|---|---|---|
| (Encoding on Coding Unit having Size of | | | | | |
| 2N × 2N and Current Depth of d) | | | | | |
| | | | Size of Transformation Unit | | |
| | | | Split | Split | |
| | Partition Type | | Information 0 | Information 1 | |
| | Symmetrical | Asymmetrical | of | of | |
| Prediction | Partition | Partition | Transformation | Transformation | Split |
| Mode | Type | Type | Unit | Unit | Information 1 |
| Intra | 2N × 2N | 2N × nU | 2N × 2N | N × N | Repeatedly |
| Inter | 2N × N | 2N × nD | | (Symmetrical | Encode |
| Skip | N × 2N | nL × 2N | | Partition Type) | Coding Units |
| (Only | N × N | nR × 2N | | N/2 × N/2 | having |
| 2N × 2N) | | | | (Asymmetrical | Lower Depth |
| | | | | Partition Type) | of d + 1 |

The output unit 830 of the video encoding apparatus 800 according to the embodiment may output the encoding information about the coding units having a tree structure, and the image data and encoding information extractor 920 of the video decoding apparatus 900 according to the embodiment may extract the encoding information about the coding units having a tree structure from a received bitstream.

Split information specifies whether a current coding unit is split into coding units of a lower depth. If split information of a current depth d is 0, a depth, in which a current coding unit is no longer split into a lower depth, is a depth, and thus partition mode information, prediction mode information, and transformation unit size information may be defined for the depth. If the current coding unit has to be further split according to the split information, encoding has to be independently performed on each of four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The partition mode information may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1.

The size of the transformation unit may be set to be two types in the intra mode and two types in the inter mode. That is, if split information of the transformation unit is 0, the size of the transformation unit may be 2N×2N, which is the size of the current coding unit. If split information of the transformation unit is 1, the transformation units may be obtained by splitting the current coding unit. If a partition mode of the current coding unit having the size of 2N×2N is a symmetrical partition mode, a size of a transformation unit may also be N×N. If the partition mode of the current coding unit is an asymmetrical partition mode, the size of the transformation unit may also be N/2×N/2.

The encoding information about coding units having a tree structure according to an embodiment may be assigned to at least one of a coding unit corresponding to a depth, a prediction unit, and a minimum unit. The coding unit corresponding to the depth may include one or more prediction units and minimum units containing the same encoding information.

Accordingly, it may be determined whether adjacent data units are included in the same coding unit corresponding to the coded depth by comparing encoding information of the adjacent data units. A coding unit corresponding to the coded depth is also determined by using encoding information of a data unit, and thus a distribution of depths in a largest coding unit may be inferred.

Accordingly, in this case, if prediction of a current coding unit is performed based on adjacent data units, encoding information of data units in deeper coding units adjacent to the current coding unit may be directly referred to and used.

In another embodiment, if prediction of the current coding unit is performed encoded based on adjacent coding units, data adjacent to the current coding unit may be searched within deeper coding units by using encoded information of adjacent deeper coding units, and thus the adjacent coding units may be referred.

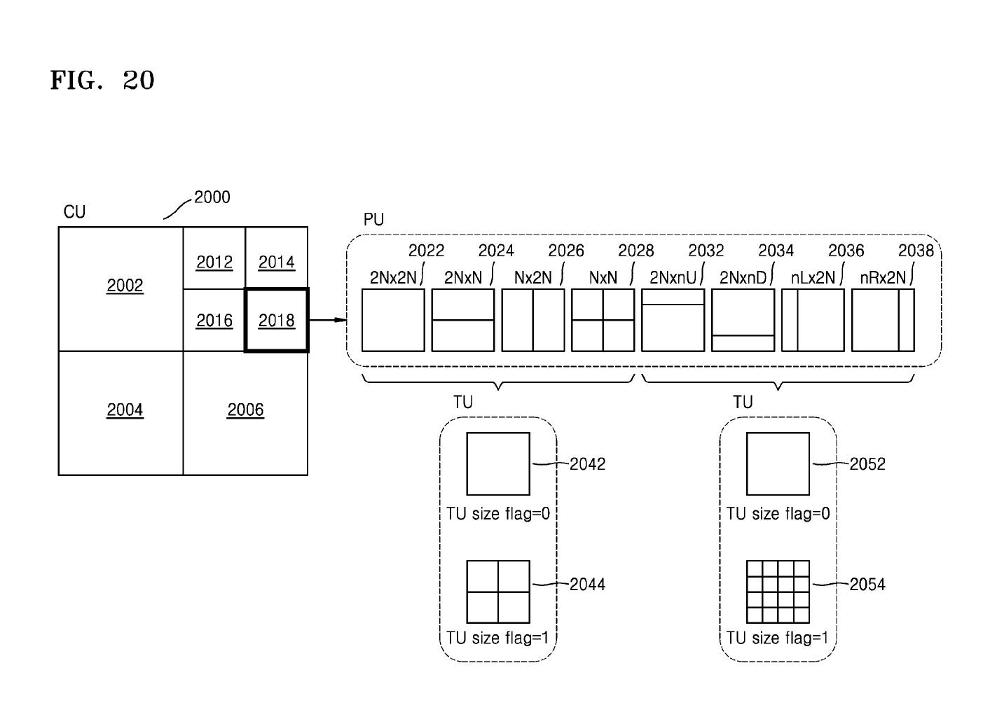

FIG. 20 illustrates a relationship between a coding unit, a prediction unit, and a transformation unit, according to encoding mode information of Table 1.

A largest coding unit 2000 includes coding units 2002, 2004, 2006, 2012, 2014, 2016, and 2018 of depths. Here, since the coding unit 2018 is a coding unit of a depth, split information may be set to 0. Partition mode information of the coding unit 2018 having a size of 2N×2N may be set to be one of partition modes including 2N×2N 2022, 2N×N 2024, N×2N 2026, N×N 2028, 2N×nU 2032, 2N×nD 2034, nL×2N 2036, and nR×2N 2038.

Transformation unit split information (TU size flag) is a type of a transformation index, and a size of a transformation unit corresponding to the transformation index may be changed according to a prediction unit type or partition mode of the coding unit.

For example, when the partition mode information is set to be one of symmetrical partition modes 2N×2N 2022, 2N×N 2024, N×2N 2026, and N×N 2028, if the transformation unit split information is 0, a transformation unit 2042 having a size of 2N×2N is set, and if the transformation unit split information is 1, a transformation unit 2044 having a size of N×N may be set.

When the partition mode information is set to be one of asymmetrical partition modes 2N×nU 2032, 2N×nD 2034, nL×2N 2036, and nR×2N 2038, if the transformation unit split information (TU size flag) is 0, a transformation unit 2052 having a size of 2N×2N may be set, and if the transformation unit split information is 1, a transformation unit 2054 having a size of N/2×N/2 may be set.

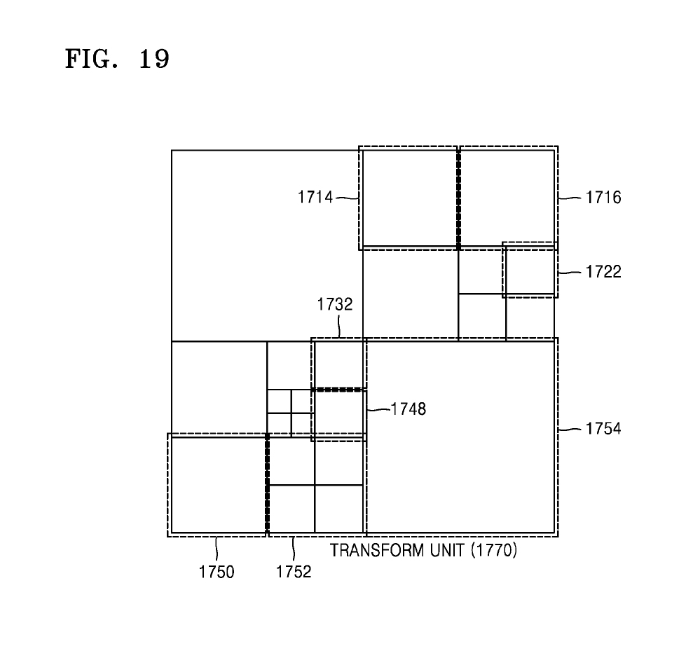

The transformation unit split information (TU size flag) described above with reference to FIG. 19 is a flag having a value or 0 or 1, but the transformation unit split information according to an embodiment is not limited to a flag having 1 bit, and the transformation unit may be hierarchically split while the transformation unit split information increases in a manner of 0, 1, 2, 3 . . . etc., according to setting. The transformation unit split information may be an example of the transformation index.

In this case, the size of a transformation unit that has been actually used may be expressed by using the transformation unit split information according to the embodiment, together with a maximum size of the transformation unit and a minimum size of the transformation unit. The video encoding apparatus 800 according to the embodiment may encode maximum transformation unit size information, minimum transformation unit size information, and maximum transformation unit split information. The result of encoding the maximum transformation unit size information, the minimum transformation unit size information, and the maximum transformation unit split information may be inserted into an SPS. The video decoding apparatus 900 according to the embodiment may decode video by using the maximum transformation unit size information, the minimum transformation unit size information, and the maximum transformation unit split information.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be smaller than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. That is, in Equation (1), ‘RootTuSize/(2̂MaxTransformSizeIndex)’ denotes a transformation unit size when the transformation unit size ‘RootTuSize’, when the TU size flag is 0, is split by the number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an embodiment, and a factor for determining the current maximum transformation unit size is not limited thereto.

According to the video encoding method based on coding units of a tree structure described above with reference to FIGS. 8 through 20, image data of a spatial domain is encoded in each of the coding units of the tree structure, and the image data of the spatial domain is reconstructed in a manner that decoding is performed on each largest coding unit according to the video decoding method based on the coding units of the tree structure, so that a video that is formed of pictures and picture sequences may be reconstructed. The reconstructed video may be reproduced by a reproducing apparatus, may be stored in a storage medium, or may be transmitted via a network.

The embodiments of the present invention may be written as computer programs and may be implemented in general-use digital computers that execute the programs by using a computer-readable recording medium. Examples of the computer-readable recording medium include magnetic storage media (e.g., ROM, floppy disks, hard disks, etc.), optical recording media (e.g., CD-ROMs, or DVDs), etc.

For convenience of description, the video encoding methods and/or the video encoding method, which are described with reference to FIGS. 1A through 20, will be collectively referred to as ‘the video encoding method of the present invention’. The video decoding methods and/or the video decoding method, which are described with reference to FIGS. 1A through 20, will also be collectively referred to as ‘the video decoding method of the present invention’.

A video encoding apparatus including the video encoding apparatus, the video encoding apparatus 800 or the video encoder 1100 which are described with reference to FIGS. 1A through 20 will also be collectively referred to as a ‘video encoding apparatus of the present invention’. A video decoding apparatus including the inter-layer video decoding apparatus, the video decoding apparatus 900, or the video decoder 1200 which are described with reference to FIGS. 1A through 20 will also be collectively referred to as a ‘video decoding apparatus of the present invention’.

A computer-readable recording medium storing a program, e.g., a disc 26000, according to an embodiment will now be described in detail.

FIG. 21 illustrates a physical structure of the disc 26000 in which a program is stored, according to an embodiment. The disc 26000, as a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantized parameter determining method, the video encoding method, and the video decoding method described above may be assigned and stored.

A computer system embodied using a storage medium that stores a program for executing the video encoding method and the video decoding method as described above will now be described with reference to FIG. 22.

FIG. 22 illustrates a disc drive 26800 for recording and reading a program by using the disc 26000. A computer system 26700 may store a program that executes at least one of the video encoding method and the video decoding method of the present invention, in the disc 26000 via the disc drive 26800. In order to run the program stored in the disc 26000 in the computer system 26700, the program may be read from the disc 26000 and may be transmitted to the computer system 26700 by using the disc drive 26800.

The program that executes at least one of the video encoding method and the video decoding method of the present invention may be stored not only in the disc 26000 illustrated in FIGS. 21 and 22 but may also be stored in a memory card, a ROM cassette, or a solid state drive (SSD).

A system to which the video encoding method and the video decoding method according to the embodiments described above are applied will be described below.

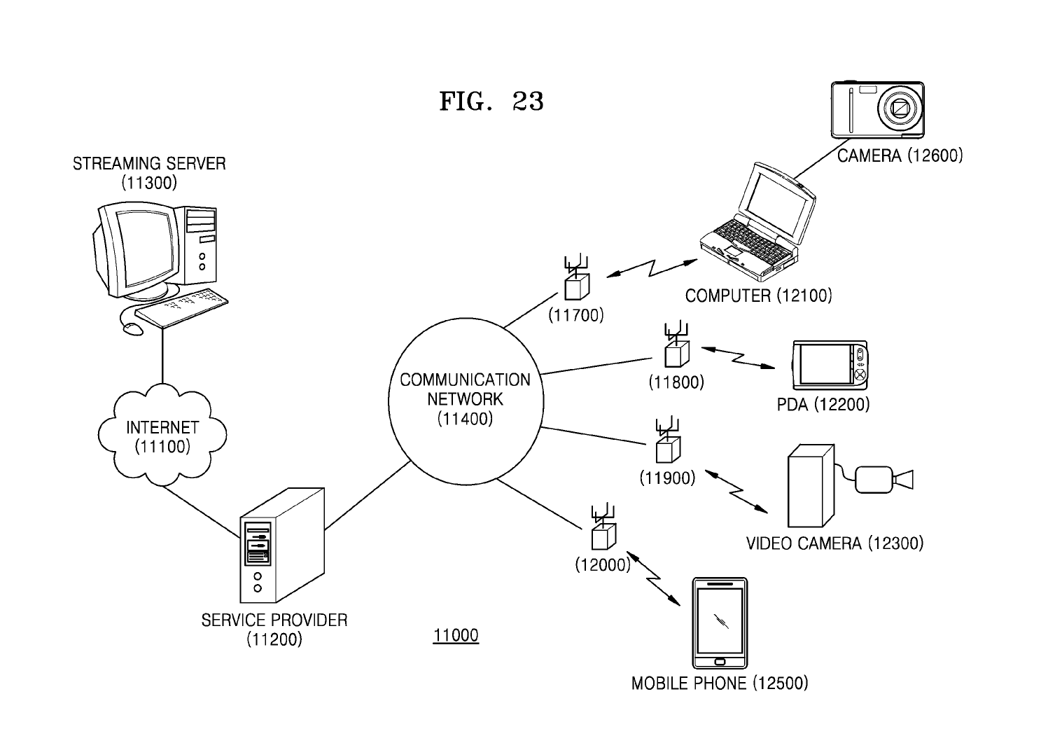

FIG. 23 illustrates an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 23, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessed by the computer 12100.

If video data is captured by a camera built in the mobile phone 12500, the video data may be received from the mobile phone 12500.

The video data may be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and may transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. The content supply system 11000 also allows the clients to receive the encoded content data and decode and reproduce the encoded content data in real time, thereby enabling personal broadcasting.

Encoding and decoding operations of the plurality of independent devices included in the content supply system 11000 may be similar to those of the video encoding apparatus and the video decoding apparatus of the present invention.

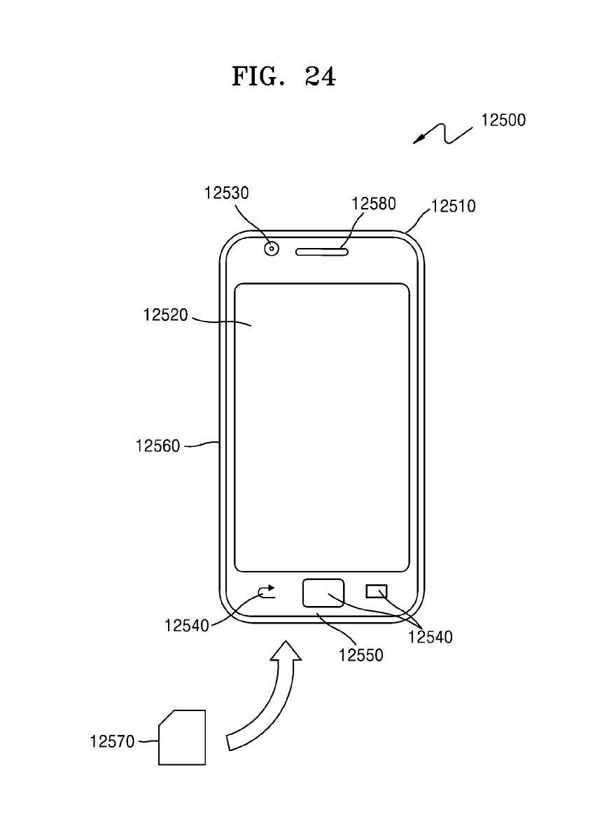

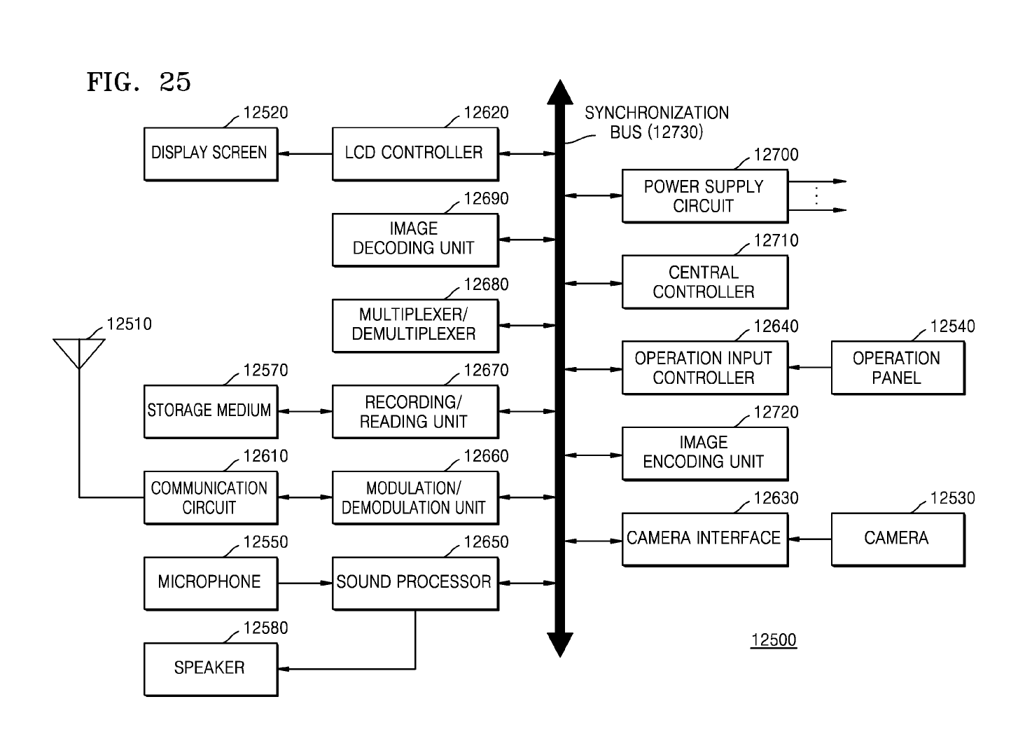

With reference to FIGS. 24 and 25, the mobile phone 12500 included in the content supply system 11000 according to an embodiment will now be described in detail.

FIG. 24 illustrates an external structure of the mobile phone 12500 to which a video encoding method and a video decoding method are applied, according to an embodiment. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of a sound output unit, and a microphone 12550 for inputting voice and sound or another type of a sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500. In order to systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 to an operation mode.

The central controller 12710 includes a CPU, a read-only memory (ROM), and a random access memory (RAM).

While the mobile phone 12500 transmits communication data to the outside, a digital signal is generated by the mobile phone 12500 under control of the central controller 12710. For example, the sound processor 12650 may generate a digital sound signal, the video encoder 12720 may generate a digital image signal, and text data of a message may be generated via the operation panel 12540 and the operation input controller 12640. When a digital signal is transmitted to the modulation/demodulation unit 12660 by control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, by control of the central controller 12710. The digital sound signal may be transformed into a transformation signal via the modulation/demodulation unit 12660 and the communication circuit 12610, and may be transmitted via the antenna 12510.

When a text message, e.g., email, is transmitted during a data communication mode, text data of the text message is input via the operation panel 12540 and is transmitted to the central controller 12610 via the operation input controller 12640. By control of the central controller 12610, the text data is transformed into a transmission signal via the modulation/demodulation unit 12660 and the communication circuit 12610 and is transmitted to the wireless base station 12000 via the antenna 12510.

In order to transmit image data during the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the video encoding apparatus 100 described above. The image encoder 12720 may transform the image data received from the camera 12530 into compressed and encoded image data according to the aforementioned video encoding method, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and analog-to-digital conversion (ADC) are performed on a signal received via the antenna 12510 to transform the signal into a digital signal. The modulation/demodulation unit 12660 modulates a frequency band of the digital signal. The frequency-band modulated digital signal is transmitted to the video decoder 12690, the sound processor 12650, or the LCD controller 12620, according to the type of the digital signal.

During the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, by control of the central controller 12710.

When during the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

In order to decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoder 12690 and the sound processor 12650, respectively.

A structure of the image decoder 12690 may correspond to that of the video decoding apparatus described above. The image decoder 12690 may decode the encoded video data to obtain reconstructed video data and provide the reconstructed video data to the display screen 12520 via the LCD controller 12620, by using the aforementioned video decoding method of the present invention.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to an exemplary embodiment, may be a transmitting terminal including only the video encoding apparatus, or may be a receiving terminal including only the video decoding apparatus.

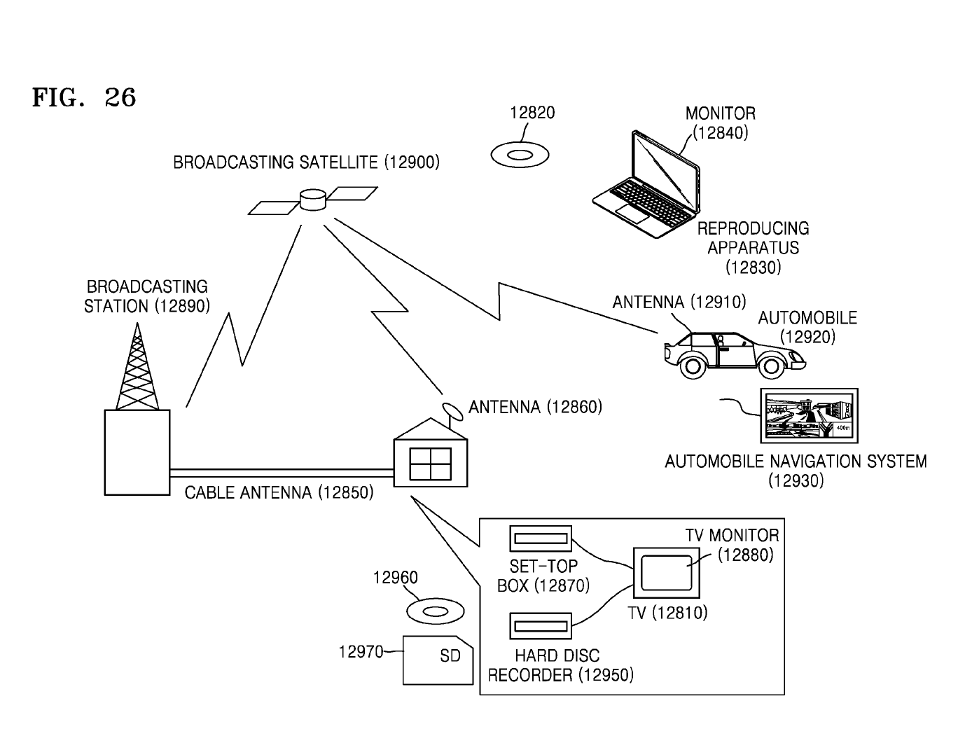

A communication system according to an embodiment is not limited to the communication system described above with reference to FIG. 24. For example, FIG. 26 illustrates a digital broadcasting system employing a communication system, according to an embodiment.

The digital broadcasting system of FIG. 26 may receive a digital broadcast transmitted via a satellite or a terrestrial network by using the video encoding apparatus and the video decoding apparatus according to the embodiments.

In more detail, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When the video decoding apparatus of the present invention is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus of the present invention may be installed. Data output from the set-top box 12870 may also be reproduced on a TV monitor 12880.

As another example, the video decoding apparatus of the present invention may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by the video encoding apparatus of the present invention and may then be stored in a storage medium. In more detail, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus according to the exemplary embodiment, a video signal recorded on the DVD disc 12960, the SD card 12970, or another storage medium may be reproduced on the TV monitor 12880.

The automobile navigation system 12930 may not include the camera 12530, the camera interface 12630, and the video encoder 12720 of FIG. 26. For example, the computer 12100 and the TV receiver 12810 may not include the camera 12530, the camera interface 12630, and the video encoder 12720 of FIG. 26.

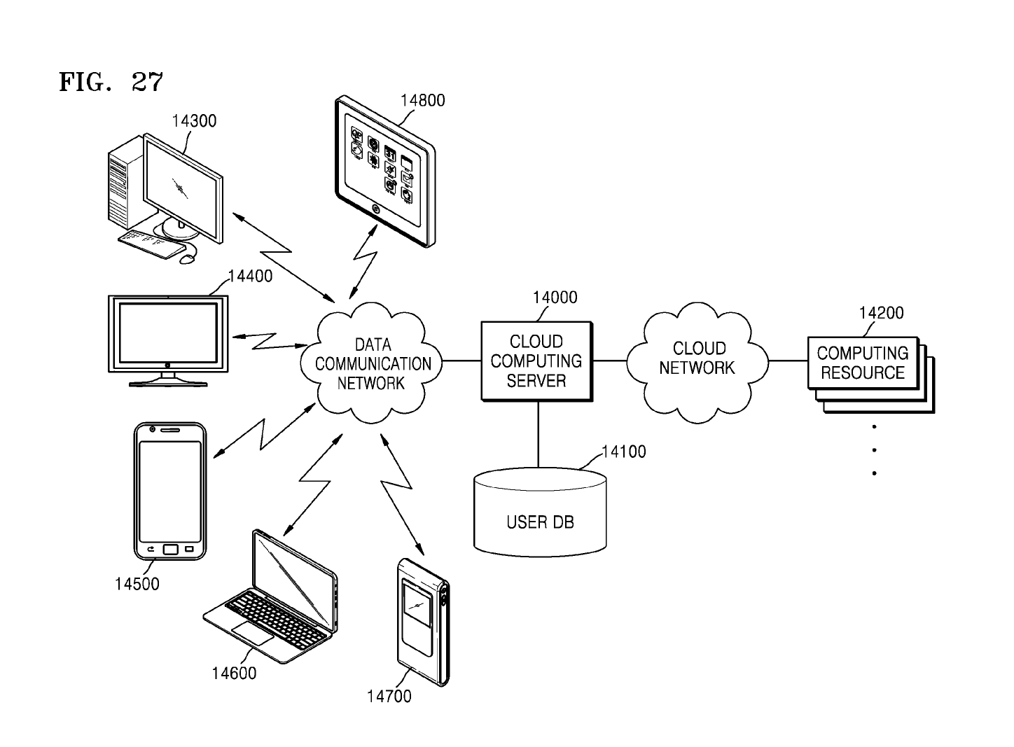

FIG. 27 illustrates a network structure of a cloud computing system using a video encoding apparatus and a video decoding apparatus, according to an embodiment.

The cloud computing system may include a cloud computing server 14100, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security software, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14100 may combine the plurality of computing resources 14200 distributed in a cloud network and provide user terminals with a result of combining. The plurality of computing resources 14200 may include various data services, and may include data uploaded from user terminals. As described above, the cloud computing server 14100 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce the video service is received from the smart phone 14500, the cloud computing server 14000 searches for and reproduces the video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. On the other hand, if the user terminal requests to reproduce the video, starting from the pausing point thereof, the cloud computing server 14000 transmits streaming data of the video starting from a frame corresponding to the pausing point, to the user terminal.

In this regard, the user terminal may include the video decoding apparatus as described above with reference to FIGS. 1A through 20. As another example, the user terminal may include the video encoding apparatus as described above with reference to FIGS. 1A through 20. Alternatively, the user terminal may include both the video encoding apparatus and the video decoding apparatus as described above with reference to FIGS. 1A through 20.

Various applications of the video encoding method, the video decoding method, the video encoding apparatus, and the video decoding apparatus described above with reference to FIGS. 1A through 20 are described above with reference to FIGS. 21 through 27. However, embodiments of methods of storing the video encoding method and the video decoding method in a storage medium or embodiments of methods of implementing the video encoding apparatus and the video decoding apparatus in a device described above with reference to FIGS. 1A through 20 are not limited to the embodiments of FIGS. 21 through 27.

The method, process, apparatus, product, and/or system according to the present invention are simple, cost-effective, various, and accurate. Furthermore, efficient and economical production, application, and utilization may be implemented by applying known values to the process, apparatus, product, and system according to the present invention. In addition, the present invention complies with current trends requiring cost reduction, system simplification, and performance enhancement. As such, the level of current technology may be enhanced.

While the present invention has been particularly shown and described with reference to specific embodiments thereof, it will be understood by one of ordinary skill in the art that various changes in form and details may be made therein without departing from the spirit and scope of the invention as defined by the following claims. The exemplary embodiments should be considered in a descriptive sense only and not for purposes of limitation. Therefore, the scope of the invention is defined not by the detailed description of the invention but by the following claims, and all differences within the scope will be construed as being included in the present invention.

1. A video decoding method comprising:
acquiring, from a bitstream, segment-wise direct component (DC) coding (SDC) mode information indicating whether an SDC mode is allowed in a depth image;
determining prediction mode information and partition mode information applied to a coding unit of the depth image;
acquiring an SDC flag indicating whether an SDC mode is applied to the coding unit from the bitstream according to the SDC mode information, the prediction mode information, and the partition mode information;
acquiring a residual DC value corresponding to a prediction unit of the coding unit from the bitstream when the SDC flag indicates that the SDC mode is applied to the coding unit; and
reconstructing a current block of the prediction unit by using the residual DC value and prediction values of the prediction unit,
wherein the residual DC value is acquired from a residual block of the prediction unit.

2. The video decoding method of claim 1, wherein the SDC mode information comprises:
inter SDC mode information indicating whether the SDC mode is allowed when the coding unit is predicted by an inter mode; and
intra SDC mode information indicating whether the SDC mode is allowed when the coding unit is predicted by an intra mode.

3. The video decoding method of claim 2, wherein the acquiring of the SDC flag comprises:
acquiring the SDC flag when a prediction mode is the inter mode, in a case where the inter SDC mode information indicates that the SDC mode is allowed with respect to the depth image, and a partition mode is a 2N×2N mode, and
acquiring the SDC flag when a prediction mode is the intra mode, in a case where the intra SDC mode information indicates that the SDC mode is allowed with respect to the depth image, and a partition mode is a 2N×2N mode.

4. The video decoding method of claim 1, wherein the acquiring of the residual DC value comprises: acquiring an absolute value of the residual DC value and, when the absolute value is not 0, acquiring a sign of the residual DC value.

5. The video decoding method of claim 1, wherein the residual DC value is determined as an average value of one or more residual pixel values of the residual block.

6. The video decoding method of claim 5, wherein the residual DC value is determined as an average value of a top left residual pixel value, a top right residual pixel value, a bottom left residual pixel value, and a bottom right residual pixel value of the residual block.

7. The video decoding method of claim 5, wherein the one or more residual pixel values are determined according to a size of at least one of the coding unit and the prediction unit.

8. The video decoding method of claim 5, wherein the residual DC value is determined from among a plurality of residual DC value candidates by adding multiple offset values to the average value of the one or more residual sample values based on rate-distortion optimization.

9. A video decoding apparatus comprising:
an SDC mode information acquirer for acquiring, from a bitstream, SDC mode information indicating whether an SDC mode is allowed in a depth image;
a coding unit information determiner for determining prediction mode information and partition mode information applied to a coding unit of the depth image;
an SDC flag acquirer for acquiring an SDC flag indicating whether an SDC mode is applied to the coding unit from the bitstream according to the SDC mode information and coding information;
a residual DC value acquirer for acquiring a residual DC value corresponding to a prediction unit of the coding unit from the bitstream when the SDC flag indicates that the SDC mode is applied to the coding unit; and
a decoder for reconstructing a current block of the prediction unit by using the residual DC value and prediction values of the prediction unit,
wherein the residual DC value is acquired from a residual block of the prediction unit.

10. The video decoding apparatus of claim 9, wherein the SDC mode information acquirer acquires inter SDC mode information indicating whether the SDC mode is allowed when the coding unit is predicted by an inter mode and acquires intra SDC mode information indicating whether the SDC mode is allowed when the coding unit is predicted by an intra mode.

11. The video decoding apparatus of claim 10, wherein the SDC flag acquirer acquires the SDC flag when a prediction mode is the inter mode, in a case where the inter SDC mode information indicates that the SDC mode is allowed with respect to the depth image, and a partition mode is a 2N×2N mode, and acquires the SDC flag when a prediction mode is the intra mode, in a case where the intra SDC mode information indicates that the SDC mode is allowed with respect to the depth image, and a partition mode is a 2N×2N mode.

12. A video encoding method comprising:
predicting a prediction unit of a coding unit of a depth image and generating a residual block corresponding to the prediction unit;
determining SDC mode information indicating whether an SDC mode is allowed with respect to the depth image;
determining a residual DC value from the residual block when the SDC mode is applied to the coding unit according to a prediction mode and a partition mode used to generate the residual block;
determining prediction mode information and partition mode information with respect to the coding unit;
determining an SDC flag indicating whether the SDC mode is applied to the coding unit; and
transmitting a bitstream comprising the SDC mode information, the SDC flag, the prediction mode information, the partition mode information, and the residual DC value.

13. A computer-readable recording medium having recorded thereon a computer program for executing the video decoding method of claim 1.

14. A computer-readable recording medium having recorded thereon a computer program for executing the video encoding method of claim 12.
